(19) United States
(12) Patent Application Publication
(10) Pub. No.: US 2023/0146355 A1
(43) Pub. Date: May 11, 2023

(54) CONSTRUCTING DERIVATIVE PROFILES FROM DISCRETE PRESSURE DATA OF TRANSIENT WELL TESTS

(71) Applicant: Saudi Arabian Oil Company, Dhahran (SA)

(72) Inventor: Noor M. Anisur Rahman, Dhahran (SA)

(21) Appl. No.: 17/520,475

(22) Filed: Nov. 5, 2021

(51) Int. Cl. G06Q 30/02; G01V 99/00; E21B 49/08; E21B 47/06

(52) U.S. Cl. CPC G06Q 30/0202; G01V 99/005; E21B 49/087; E21B 47/06; E21B 2200/20

(57) ABSTRACT

Systems and methods include a computer-implemented method for using first- and second-order derivatives from discrete pressure data of a well to characterize the well and intersected reservoir under dynamic conditions. Discrete data for the well and associated reservoir is arranged chronologically. First- and second-order derivatives of pressure versus a time series are determined at a first focal point using a five-point function considering beginning and ending points in a time period. First- and second-order derivatives are determined at successive focal points, applying terminal corrections. Numerical values and plots of first- and second-order derivative profiles are presented. Diagnostic plots and data for determining geological features for the associated reservoir and well parameters are generated. Reservoir simulation models are executed to generate a forecast of future production rates under different constraints. A production strategy and future development plans for the well are managed, and future sales revenue estimates are provided.

### TECHNICAL FIELD

The present disclosure applies to measured pressure points in transient well tests.

### BACKGROUND

Transient well tests can be performed on hydrocarbon and water wells to characterize reservoirs from a dynamic point of view or to replicate actual operating conditions in the oilfield. The transient well tests can be performed on the hydrocarbon and water wells under controlled environments for collecting transient-pressure data through downhole gauges.

### SUMMARY

The present disclosure describes techniques that can be used for constructing and using first- and second-order derivatives from discrete pressure data of a well to characterize the well and the contacted reservoir under dynamic conditions. In some implementations, a computer-implemented method includes the following. Discrete data for production of a well and an associated reservoir are arranged in chronological order over a time period. First- and second-order derivatives of pressure versus a time series in the well and the associated reservoir are determined at a first focal point in the time period. The first- and second-order derivatives are determined using a five-point function. The five-point function considers beginning and ending points in the time period. The first- and second-order derivatives are determined at a next focal point following the determination of the first- and second-order derivatives for the first focal point. The first- and second-order derivatives are determined at all the successive focal points, applying the terminal corrections wherever deemed necessary. Numerical values and plots of first- and second-order derivative profiles that are based on the first- and second-order derivatives are presented in a user interface. Diagnostic plots and data for determining geological features for the associated reservoir and well parameters for the well are generated using the first- and second-order derivative profiles. Reservoir simulation models are executed using an input reservoir description, including well and reservoir parameters, to generate a forecast of future production rates under different constraints. A production strategy and future development plans for the well are managed, and estimates of future sales revenue for the well are provided using the forecast of future production rates.

The previously described implementation is implementable using a computer-implemented method; a non-transitory, computer-readable medium storing computer-readable instructions to perform the computer-implemented method; and a computer-implemented system including a computer memory interoperably coupled with a hardware processor configured to perform the computer-implemented method, the instructions stored on the non-transitory, computer-readable medium.

The subject matter described in this specification can be implemented in particular implementations, so as to realize one or more of the following advantages. Dual derivatives can be used in diagnosing low-grade reservoir heterogeneity from both flow and build-up tests. This solves the problem of conventional algorithms that are not practical for computing second-order derivatives with discrete data points, especially at the end points of a time period. A core five-point computational method is utilized for the vast majority of computations with the intermediate data points in between the end points. Special procedures can be applied to the end points in the data set. All the chronologically-ordered data points, from the first to the last data points, contribute to the accuracy, continuity and shapes of derivative profiles. Capturing the accurate magnitudes and the shape are particularly important in determining the well and the reservoir parameters under dynamic conditions. These parameters are input to reservoir simulation models, which provide forecasts of production under different operating conditions. These forecast values of production are utilized in the field development plans, reservoir management with production strategies, and estimates of future sales revenue.

The details of one or more implementations of the subject matter of this specification are set forth in the Detailed Description, the accompanying drawings, and the claims. Other features, aspects, and advantages of the subject matter will become apparent from the Detailed Description, the claims, and the accompanying drawings.

### DESCRIPTION OF DRAWINGS

FIG. 1 is a diagram showing an example of a well schematic used in a typical downhole set-up for running drill-stem tests, according to some implementations of the present disclosure.

FIG. 2 is a diagram showing an example of a workflow demonstrating role of constructing derivative profiles in long-term production forecasting of a hydrocarbon field, according to some implementations of the present disclosure.

FIG. 3 is a graph showing an example of discrete data points of a well test, according to some implementations of the present disclosure.

FIG. 4 is a graph showing an example of an evaluation of derivatives at a first data point using information of five neighboring discrete points on the graph, according to some implementations of the present disclosure.

FIG. 5 is a graph showing an example of an evaluation of derivatives at a second data point using information of five neighboring discrete points on the graph, according to some implementations of the present disclosure.

FIG. 6 is a graph showing an example of an evaluation of derivatives at intermediate data points using information of five neighboring discrete points, according to some implementations of the present disclosure.

FIG. 7 is a graph showing an example of an evaluation of derivatives at second last data point using information of five neighboring discrete points, according to some implementations of the present disclosure.

FIG. 8 is a graph showing an example of an evaluation of derivatives at last data point using information of five neighboring discrete data points, according to some implementations of the present disclosure.

FIG. 9 is a diagram showing an example of a workflow of a derivative calculator, according to some implementations of the present disclosure.

FIG. 10 is a diagram showing an example of a grand algorithm (GA) using input raw data to generate derivative profiles, according to some implementations of the present disclosure.

FIG. 11 is a diagram showing an example of a graph showing a comparison of computed primary pressure derivatives with respective values of analytical solution derivatives 1104, according to some implementations of the present disclosure.

FIG. 12 is a diagram showing an example of a graph showing a comparison of computed well-test derivatives to the respective values analytical solution derivatives, according to some implementations of the present disclosure.

FIG. 13 is a diagram illustrating an example of a graph showing a comparison of computed dual derivatives to the respective values of analytical solution derivatives, according to some implementations of the present disclosure.

FIG. 14 is a diagram showing an example of a pressure history of a multi-rate test, according to some implementations of the present disclosure.

FIG. 15 is a diagram showing an example of a superposition time function, according to some implementations of the present disclosure.

FIG. 16 is a semi-log plot diagram showing an example of comparative magnitudes of dual, well-test and second-order derivatives in respective profiles, according to some implementations of the present disclosure.

FIG. 17 is a diagram showing an example of comparative magnitudes of dual and well-test derivatives in respective profiles, according to some implementations of the present disclosure.

FIG. 18 is a diagram showing an example of a zoomed-in view of dual derivative profile during an early time into shut-in period, according to some implementations of the present disclosure.

FIG. 19 is a flowchart of an example of a method for constructing and using first- and second-order derivatives from discrete pressure data of a well to characterize the well and make changes in production, according to some implementations of the present disclosure.

FIG. 20 is a block diagram illustrating an example computer system used to provide computational functionalities associated with described algorithms, methods, functions, processes, flows, and procedures as described in the present disclosure, according to some implementations of the present disclosure.

Like reference numbers and designations in the various drawings indicate like elements.

### DETAILED DESCRIPTION

The following detailed description describes techniques for constructing and using first- and second-order derivatives from discrete pressure data of a well to characterize the well and the intersected reservoir under dynamic conditions. Various modifications, alterations, and permutations of the disclosed implementations can be made and will be readily apparent to those of ordinary skill in the art, and the general principles defined may be applied to other implementations and applications, without departing from scope of the disclosure. In some instances, details unnecessary to obtain an understanding of the described subject matter may be omitted so as to not obscure one or more described implementations with unnecessary detail and inasmuch as such details are within the skill of one of ordinary skill in the art. The present disclosure is not intended to be limited to the described or illustrated implementations, but to be accorded the widest scope consistent with the described principles and features.

### Introduction

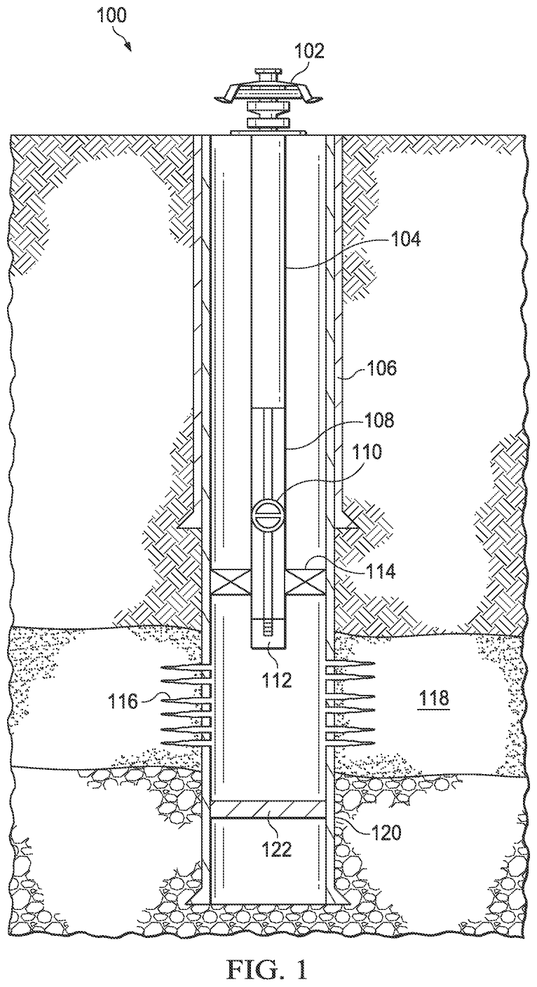

FIG. 1 is a diagram showing an example of a well schematic 100 used in a typical downhole set-up for running drill-stem tests, according to some implementations of the present disclosure. A drill-stem test can be controlled by a testing flow-head 102 using tubing 104 running through casing 106 (for example, a series of steel pipes). A drill stem test (DST) string 108 includes a tester valve 110. At the end of the drill string are one or more downhole gauges 112 record pressure and temperature readings over time at a pre-set sampling rate, for example every second to a few seconds, for hours (hrs) to days. Retrievable packers 114 can hold the drill string in place. Perforations 116 can be cut in the well at locations of reservoirs 118. Liners 120 can be used to achieve zonal isolation 122.

Data obtained from drill-stem tests can be combined with the fluid production or injection rates and the rock and fluid properties to characterize the well and the completed reservoir. Such an analysis of data can provide valuable dynamic parameters for the subject well and the subject reservoir. These parameters can subsequently become dominant input to building large reservoir simulation models. The models can provide a strategic understanding of how to develop and manage a reservoir, and to predict future performance with production and injection for economics. It is important to estimate accurate well and reservoir parameters from well-test data to make sure that simulation models are rightfully treated with accurate reservoir description and dynamic input parameters. Poor input parameters out of dynamic data to reservoir simulation models can make the simulation models susceptible to misleading production forecasts, for example, exaggerated or pessimistic oil or gas production rates for subsequent decades of production. Accurate characterization of the well and the reservoir can have far-reaching consequences in oilfield operations. The presented disclosure is relevant to one of the aspects of how dynamic characterization of wells and reservoirs is performed.

Pressure data is typically reported every few seconds during well or transient-pressure testing. A total number of such discrete data points can range from a few thousand to a few million, depending on the test duration. It is important to diagnose transient behaviors in the reservoir by reviewing pressure-derivative profiles plotted over time. Modern approaches include identifying geological features in the reservoir under investigation in the corresponding derivative profiles. Although monotonic changes in the smooth-looking profiles due to geological features in the reservoir or well behaviors may appear to be normal, any discontinuity, corners, or abrupt changes in the profiles are likely to be the artifacts of constructing such profiles out of discrete pressure data. Simple derivative profiles can be constructed out of discrete pressure versus (vs) time data only based on single-rate (injection or fall off) well tests. However, in multi-rate well tests, the production or injection rates can be convolved through the superposition of a time function with the discrete pressure data in computing the derivatives, which can influence the derivative profiles. The present disclosure presents techniques for constructing two types of derivative profiles by calculating first- and second-order derivatives of pressure with respect to time at each discrete point in the data set. Calculating good, representative values of derivatives at discrete points is key to creating smooth profiles of derivatives. Computations of derivatives at each discrete point, termed as a focal point, can also use the data of four other immediate points around this focal point. As a result, pressure values of five chronologically-ordered, consecutive data points can be used to represent first-order and second-order derivatives at one of those five points. These additional neighboring (or adjacent) points can provide pacification and moderation to the curvature of derivative profiles. Moreover, artifacts of computations can be minimized in the derivative values, and reservoir signals based on discrete points can be restored in the resulting derivative profiles.

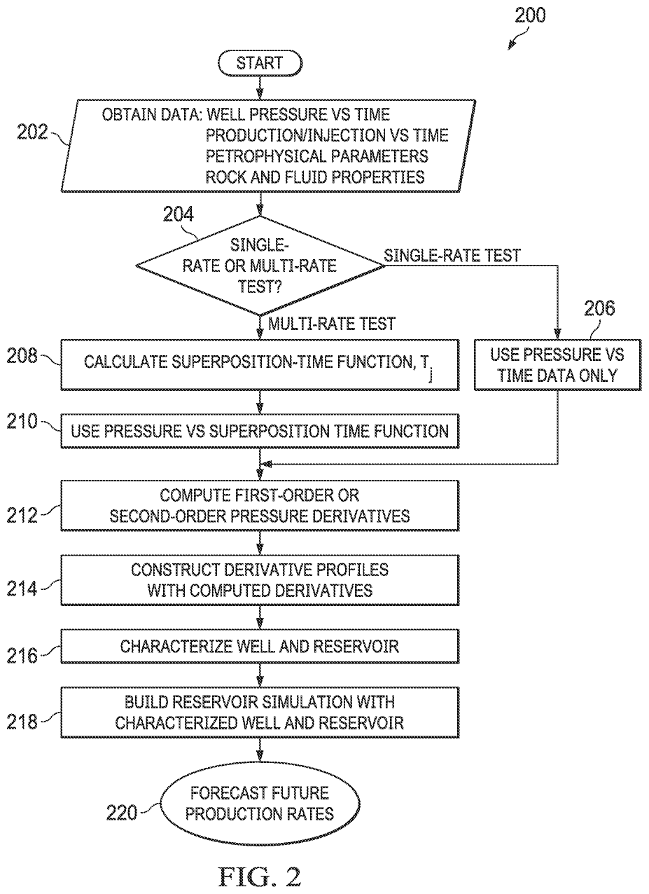

FIG. 2 is a diagram showing an example of a workflow 200 demonstrating role of constructing derivative profiles in long-term production forecasting of a hydrocarbon field, according to some implementations of the present disclosure. At 202, well data is obtained, including well pressure vs. time, production/injection vs. time, petrophysical parameters, and rock and fluid properties. At 204, a decision is made which track to follow based on the type of test already performed (a single-rate or a multi-rate test). A single-rate test uses pressure vs. time data only at 206. In a multi-rate test, superposition-time function Tᵢ is calculated at 208, and pressure vs. the superposition-time function is used at 210. At 212, for both single-rate and multi-rate tests, first-order or second-order pressure derivatives are computed. At 214, derivative profiles with computed derivative are constructed. At 216, the well and the reservoir are characterized based on the profiles and derivatives. At 218, a reservoir simulation is built using the characterizations of the well and reservoir. At 220, future production rates are forecast.

As presented in the workflow of FIG. 2, construction of derivative profiles follows either a time tract or a superposition time function tract, depending on the type of well tests (single-rate test or multi-rate test, respectively). In the case of a multi-rate test, the superposition time function needs to be calculated a priori with the production or injection rates over time for each point in time. This magnitude of the superposition time function for corresponding time value can be used to replace any time value in the subsequent computation of derivatives. For brevity and simplicity in the present disclosure, equations and processes are presented in terms of time data, which appears to be single-rate data. As mentioned previously, an adjustment can be made by replacing the time with the corresponding magnitude of the superposition time function for multi-rate tests or wherever it is necessary to do so.

First-order derivatives can be used in different applications, including in primary pressure derivatives which require only pressure versus time data. The primary pressure derivative is simply the first-order derivative of pressure with respect to time. Well-test derivatives can use pressure versus time and rate versus time data for constructing a superposition time function. The first-order derivatives, with respect to the superposition time function, can lead to the well-test derivatives.

Second order-derivatives can lead to computing dual derivatives, which are more sensitive for diagnosing reservoir heterogeneity by demonstrating features of variations. A simple form of the dual derivative is based on multiplication of the second-order derivative by a time-squared term in a single-rate test. As will be demonstrated in the present disclosure, dual derivatives can be calculated by introducing the second-order derivatives with respect to the superposition time function in multi-rate tests. Advantages of dual derivatives can become obvious in identifying reservoir heterogeneity when the reservoir properties change in space. Traditional well-test derivatives do not demonstrate such sensitivity, especially in low-grade heterogeneity.

### Organization of Data Points to be Considered in Estimating Derivatives

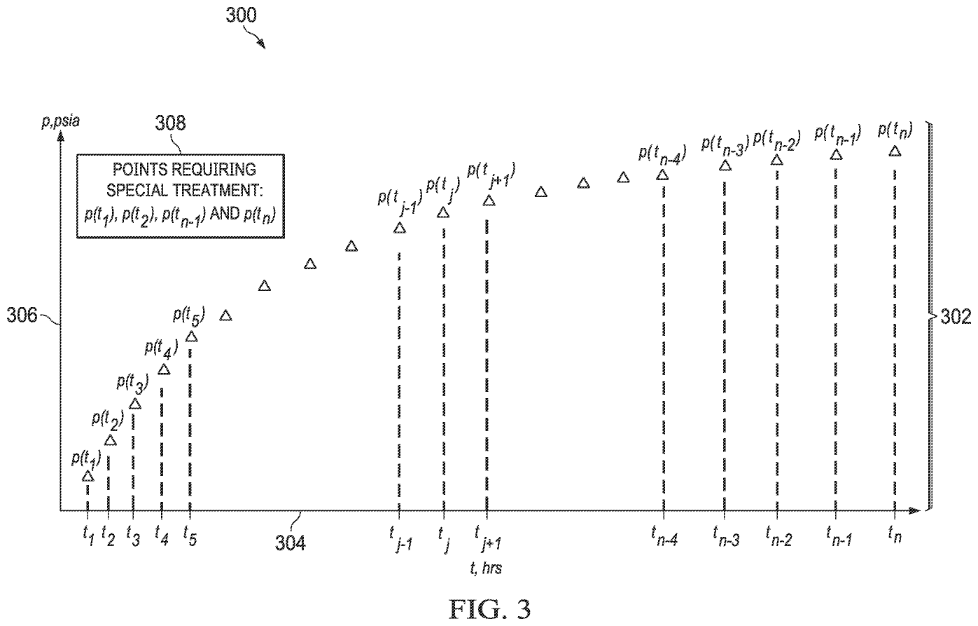

Organization of arbitrary n data points typically includes ordering the points chronologically in ascending order of the time series. This is done so that t₁<t₂<t₃<t₄<t₅<t₆< . . . <tⱼ₋₂<tⱼ₋₁<tⱼ<tⱼ₊₁<tⱼ₊₂< . . . <tₙ₋₄<tₙ₋₃<tₙ₋₂<tₙ₋₁<tₙ. This time series does not need to be equidistant, and grid sizes do not need to be equal. Corresponding pressure values, p(t₁), p(t₂), p(t₃), p(t₄), p(t₅), . . . , p(tₙ₋₄), p(tₙ₋₃), p(tₙ₋₂), p(tₙ₋₁) and p(tₙ), can be of any magnitudes as per measurements. An example organization of the data is illustrated in FIG. 3.

FIG. 3 is a graph 300 showing an example of discrete data points 302 of a well test, according to some implementations of the present disclosure. As shown, t₁, t₂, and t₃, are considered the first, second, and third data points, and tₙ₋₁, and to are the second last and last data points in the series, respectively. The discrete data points 302 are plotted relative to a time (t) axis 304 (for example, in hrs) and a pressure (p) axis 306, for example, in pounds per square inch absolute (psia). As the approach of evaluating derivatives is based on five points, the first- and second-order derivatives at each point are evaluated by using the pressure value at a given point and the pressure values at the four other neighboring points. The values of the neighboring data points can provide the representative curvature in the resulting derivative profiles. As described in more detail below, the evaluations at four terminal points in a given data set are treated differently from the ones that are the mainstream data points. These special treatments are to avoid any end effects in the resulting derivative profiles. Key 308 identifies the discrete data points that require special treatment.

Normally the estimations of derivatives begin at point 1 (t₁,p(t₁)) first, followed by point 2 (t₂,p(t₂)), then point 3 (t₃,p(t₃)), and so on. With this progression, point n (tₙ,p(tₙ)) is taken care of in the end.

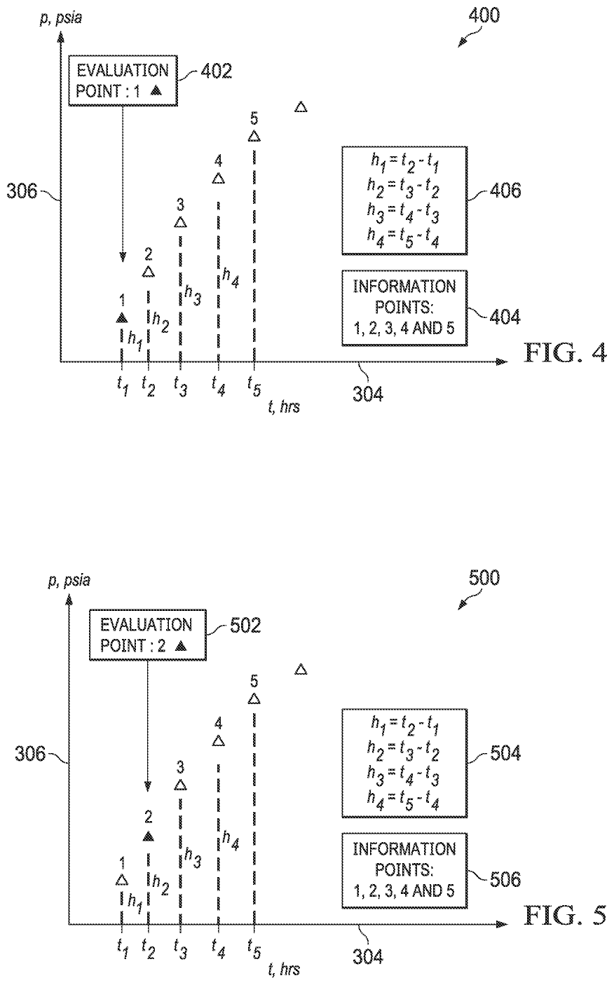

FIG. 4 is a graph 400 showing an example of an evaluation of derivatives at a first data point 402, t₁, according to some implementations of the present disclosure. Grid size equations 404 can use information 406 of five neighboring discrete points. In this example, a derivative for point 1 can be estimated using pressure values at point 1 with an additional four other points to the right of point 1 on the graph 400. Note that there are no other points on the left to point 1 on the graph 400. Due to the asymmetric distribution of the values about point 1, the computations at this point require special treatments so that the resulting derivatives do not suffer from the end effects. This example, and the examples for FIGS. 5-8, will be reflected in the computational procedure later.

FIG. 5 is a graph 500 showing an example of an evaluation of derivatives at a second data point 502, t₂, using information of five neighboring discrete points on the graph 500, according to some implementations of the present disclosure. Grid size equations 504 can use information 506 of five neighboring discrete points. For example, FIG. 5 shows that the derivatives are estimated at point 2, using pressure values at point 2 with an additional point to the left and three other points to the right on the graph 500. Due to the asymmetric distribution of the values about point 2, the computations at this point require special treatments so that the resulting derivatives do not suffer from the end effects.

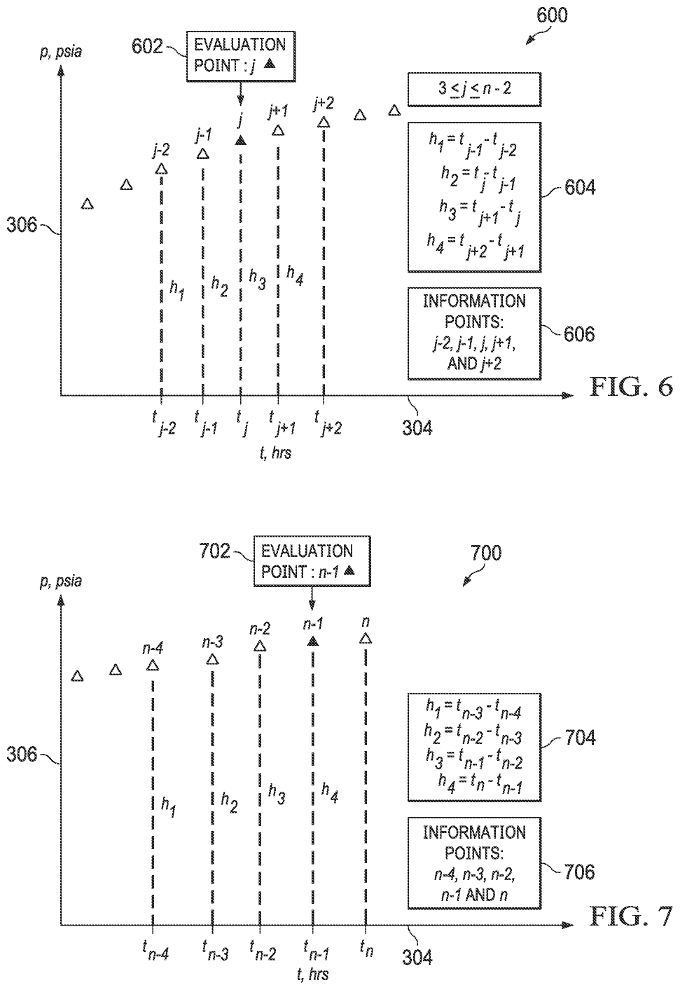

FIG. 6 is a graph 600 showing an example of an evaluation of derivatives at intermediate data points 602, tⱼ, using information of five neighboring discrete points, according to some implementations of the present disclosure. FIG. 6 shows that the derivatives are estimated at intermediate points, which are located away from the early or the late data points and do not require any special treatments. For example, grid size equations 604 can use information 606 of five neighboring discrete points without any special treatment. Here, an arbitrary point j is such that the computations of derivatives can use values in a balanced way with the information of the two points on the left side and the two points on the right side on the graph 600, including the focal point j. To qualify for this mainstream approach, point j has to be positioned such that 3≤j≤n−2. This means that point j can be any point in the data set, except the terminal points on the graph 500. Terminal points (1, 2, n−1, and n) turn out to be asymmetric and require special treatments when estimating the respective derivatives. Due to the symmetric distribution of the values about point j, the computations at this point do not require any special treatments. Except at the four terminal data points in the entire data set of hundreds of thousands data points in a given set of pressure data, this mainstream approach of involving five data points is to be followed.

FIG. 7 is a graph 700 showing an example of an evaluation of derivatives at second last data point 702, tₙ₋₁, using information of four neighboring discrete points, according to some implementations of the present disclosure. Grid size equations 704 can use information 706 of five neighboring discrete points. For example, FIG. 7 shows that the derivatives are estimated at point n−1 on the graph 700 (the second last point in the data set), using pressure values at point n−1 with additional three points to the left and the last available point n to the right in the data set. Due to the asymmetric distribution of the values about point n−1, the computations at this point require a special treatment so that the resulting derivatives do not suffer from the end effects.

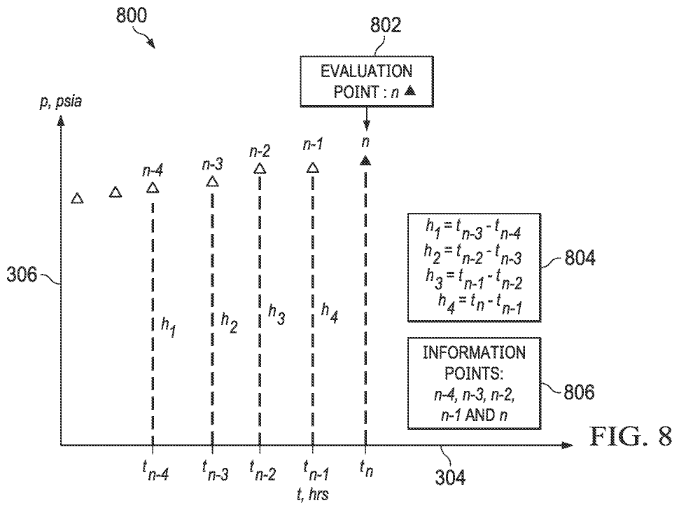

FIG. 8 is a graph 800 showing an example of an evaluation of derivatives at last data point 802, tₙ, using information of four neighboring discrete data points, according to some implementations of the present disclosure. Grid size equations 804 can use information 806 of five neighboring discrete points. For example, FIG. 8 illustrates how the derivatives are estimated at the last point n in the data set, using pressure values at point n with additional four points to the left on the graph 800 in the data set. Due to the asymmetric distribution of the values about point n, the computations at this point require special treatment so that the resulting derivatives do not suffer from the end effects. Correcting derivatives at the terminals or ends properly also enables the continuity of the derivative profiles, averts unfair skewness, and ensures the accuracy and integrity of the final, representative profiles. In this way, all the data points fairly represent the constructed derivative profiles with no wastage of any data points.

As described previously, the core five-point technique of computing derivatives applies to the vast majority of data points in a given set. Only four terminal points in the data set require special treatment so that the presentation of derivative profiles over time appear smooth and continuous at the two ends (beginning and ending). If these four terminal points are not corrected properly, the magnitudes and the profiles of derivatives in the early and the late times can be distorted due to the reverberation effects as observed in conventional systems. Such distortions sweep through much wider than the targeted four points in the data, causing a substantial loss of analytical capability. The figures of the present disclosure present time as an independent variable. Similar illustrations can be made with the superposition time function, especially in multi-rate tests, including build-up tests. The superposition time function helps transform multi-rate cases to behave as if they are single-rate cases.

### Computing First- and Second-Order Derivatives at Each Data Point

Pressure values at the focal point and at four other neighboring points are utilized in computing the first- and second-order derivatives. This approach of computation is based on five points including the focal point. The focal point is the point at which the derivatives are being calculated. In the core five-point computational approach, the focal point takes information of the two immediate neighboring points on the left and two other neighboring point on the right, including its own. Such approaches can cause skewness to the computed derivatives at the first, the second, the second to last and the last points due to a bias towards one side over the other side around the focal point. To prevent such skewness, special treatments can be applied to these terminal points in the data set. Most of the equations are presented in tables for brevity. Grid sizes, h₁, h₂, h₃, and h₄, at the focal point are illustrated in FIGS. 4 through 8, based on the location of the point. Conventionally, units of time are converted to hours even if the raw data of well test from the oilfield returns in seconds. As such, the grid sizes are constructed in hours, and subsequently derived parameters just follow along: pressure in psia and grid sizes in hours. Note that all the equations and examples presented in the present disclosure are based on the system of US Oilfield units. Nevertheless, any variations from the system of US Oilfield units or conversions to another system of units can readily be accommodated. Although the equations may look structurally similar at different points or between the types of derivatives, the persons skilled in the art will be able to differentiate the inherent subtleness while following the procedure.

Applying equations for individual derivatives at a point on all five consecutive points with a focus on one point at a time results in the following system of linear equations:

A̅X̅=B̅ (1)

where A̅ is a 4×4 matrix containing geometrical properties of the four grids h₁, h₂, h₃ and h₄, due to the four additional neighboring points around the focal point, and X̅ is a 4×1 vector of the dependent coefficients (four coefficients out of a, b, c, d, and e). Note that both matrix A̅ and vector X̅ depend on the focal point of evaluation and the type of derivatives being sought. For example, if the first-order derivatives are being evaluated at t₁, then the dependent coefficients b, c, d, and e, are used to populate vector X̅. Similarly, if t₂ is the time of evaluation, then a, c, d, and e are the dependent coefficients in vector X̅. More information on vector X̅ is described below.

Table 1 presents the parameters that are important in computing derivatives at each point in the data set, starting from point 1 all the way to the nth or the last point in preparation for constructing matrix A̅ for both types of derivatives. Table 2 presents the elements of matrix, A̅, and vector, B̅. Note that the matrix, A̅, presented in Table 2, is structurally identical at a given point for both types of the first- and second-order derivatives. Table 2 also shows vector, B̅, is different for the two types of derivatives. The set of four independent variables as the elements of vector, X̅, is determined from the solution to Equation (1) as:

X̅=A̅⁻¹B̅ (2)

As Equation (2) determines four coefficients out of the five coefficients a, b, c, d and e, the fifth coefficient is determined from the following equations:

a+b+c+d+e=0 (3)

TABLE 1
Sequence of Calculations at n Discrete Data Points.

| | | Calculation | Calculation |
|---|---|---|---|
| Sequence | | of p′: | of p″: |
| of Data | Illustration, | Column | Column |
| Point (s) | FIG. no. | in Table 3 | in Table 4 |
| t₁ | FIG. 4 | 2nd Column | 2nd Column |
| | Quantify: | Quantify: | Quantify: |
| | h₁, h₂, h₃, h₄ | p₁, q₁, r₁, s₁ | p₁, q₁, r₁, s₁ |
| | | p₂, q₂, r₂, s₂ | p₂, q₂, r₂, s₂ |
| | | p₃, q₃, r₃, s₃ | p₃, q₃, r₃, s₃ |
| | | p₄, q₄, r₄, s₄ | p₄, q₄, r₄, s₄ |
| t₂ | FIG. 5 | 3rd Column | 3rd Column |
| | Quantify: | Quantify: | Quantify: |
| | h₁, h₂, h₃, h₄ | p₁, q₁, r₁, s₁ | p₁, q₁, r₁, s₁ |
| | | p₂, q₂, r₂, s₂ | p₂, q₂, r₂, s₂ |
| | | p₃, q₃, r₃, s₃ | p₃, q₃, r₃, s₃ |
| | | p₄, q₄, r₄, s₄ | p₄, q₄, r₄, s₄ |
| tj | FIG. 6 | 4th Column | 4th Column |
| when | Quantify: | Quantify: | Quantify: |
| 3 ≤ j ≤ n − 2 | h₁, h₂, h₃, h₄ | p₁, q₁, r₁, s₁ | p₁, q₁, r₁, s₁ |
| | | p₂, q₂, r₂, s₂ | p₂, q₂, r₂, s₂ |
| | | p₃, q₃, r₃, s₃ | p₃, q₃, r₃, s₃ |
| | | p₄, q₄, r₄, s₄ | p₄, q₄, r₄, s₄ |
| tₙ₋₁ | FIG. 7 | 5th Column | 5th Column |
| | Quantify: | Quantify: | Quantify: |
| | h₁, h₂, h₃, h₄ | p₁, q₁, r₁, s₁ | p₁, q₁, r₁, s₁ |
| | | p₂, q₂, r₂, s₂ | p₂, q₂, r₂, s₂ |
| | | p₃, q₃, r₃, s₃ | p₃, q₃, r₃, s₃ |
| | | p₄, q₄, r₄, s₄ | p₄, q₄, r₄, s₄ |
| tₙ | FIG. 8 | 6th Column | 6th Column |
| | Quantify: | Quantify: | Quantify: |
| | h₁, h₂, h₃, h₄ | p₁, q₁, r₁, s₁ | p₁, q₁, r₁, s₁ |
| | | p₂, q₂, r₂, s₂ | p₂, q₂, r₂, s₂ |
| | | p₃, q₃, r₃, s₃ | p₃, q₃, r₃, s₃ |
| | | p₄, q₄, r₄, s₄ | p₄, q₄, r₄, s₄ |

TABLE 2
Construction of Matrix, A̅, and Vector, B̅, for Each Type of Derivatives

| Equation | A̅ for Calculating | B̅ for | B̅ for |
|---|---|---|---|
| No. 1 | p′ and p″ | Calculating p′ | Calculating p″ |
| A̅ X̅ = B̅ | $\overline{\overline{A}} = [ \begin{matrix}{p}_{1} & {q}_{1} & {r}_{1} & {s}_{1} \\ {p}_{2} & {q}_{2} & {r}_{2} & {s}_{2} \\ {p}_{3} & {q}_{3} & {r}_{3} & {s}_{3} \\ {p}_{4} & {q}_{4} & {r}_{4} & {s}_{4}\end{matrix} ]$ | $\overline{B} = [ \begin{matrix}1 \\ 0 \\ 0 \\ 0\end{matrix} ]$ | $\overline{B} = [ \begin{matrix}0 \\ 2 \\ 0 \\ 0\end{matrix} ]$ |

Tables 3 and 4 provide a guide on how to compute all the elements of matrix A̅ for the first- and the second-order derivatives from the grid sizes at a given type of focal point(s). These tables also provide the four elements of vector X̅ of each focal point for both types of derivatives, which have not been explicitly defined earlier. More discussion on computing the elements of vector X̅ and the rest of Tables 3 and 4 follows.

TABLE 3
Parameters for First-Order Derivatives at Every Chronological Point

| | | | Evaluate | | |
|---|---|---|---|---|---|
| | Evaluate | Evaluate | p′ (tⱼ) when | Evaluate | Evaluate |
| | p′ (t₁) | p′ (t₂) | 3 ≤ j ≤ n − 2 | p′ (tₙ₋₁) | p′ (tₙ) |
| p₁ | h₁ | −h₁ | −(h₁ + h₂) | −(h₁ + h₂ + h₃) | −(h₁ + h₂ + h₃ + h₄) |
| q₁ | h₁ + h₂ | h₂ | −h₂ | −(h₂ + h₃) | −(h₂ + h₃ + h₄) |
| r₁ | h₁ + h₂ + h₃ | h₂ + h₃ | h₃ | −h₃ | −(h₃ + h₄) |
| s₁ | h₁ + h₂ + h₃ + h₄ | h₂ + h₃ + h₄ | h₃ + h₄ | h₄ | −h₄ |
| p₂ | h₁² | h₁² | (h₁ + h₂)² | (h₁ + h₂ + h₃)² | (h₁ + h₂ + h₃ + h₄)² |
| q₂ | (h₁ + h₂)² | h₂² | h₂² | (h₂ + h₃)² | ( h₂ + h₃ + h₄)² |
| r₂ | (h₁ + h₂ + h₃)² | (h₂ + h₃)² | h₃² | h₃² | (h₃ + h₄)² |
| s₂ | (h₁ + h₂ + h₃ + h₄)² | ( h₂ + h₃ + h₄)² | (h₃ + h₄)² | h₄² | h₄² |
| p₃ | h₁³ | −h₁³ | −(h₁ + h₂)³ | −(h₁ + h₂ + h₃)³ | (h₁ + h₂ + h₃ + h₄)³ |
| q₃ | (h₁ + h₂)³ | h₂³ | −h₂³ | −(h₂ + h₃)³ | (h₂ + h₃ + h₄)³ |
| r₃ | (h₁ + h₂ + h₃)³ | (h₂ + h₃)³ | h₃³ | −h₃³ | (h₃ + h₄)³ |
| s₃ | (h₁ + h₂ + h₃ + h₄)³ | (h₂ + h₃ + h₄)³ | (h₃ + h₄)³ | h₄³ | h₄³ |
| p₄ | h₁⁴ | h₁⁴ | (h₁ + h₂)⁴ | (h₁ + h₂ + h₃)⁴ | (h₁ + h₂ + h₃ + h₄)⁴ |
| q₄ | (h₁ + h₂)⁴ | h₂⁴ | h₂⁴ | (h₂ + h₃)⁴ | ( h₂ + h₃ + h₄)⁴ |
| r₄ | (h₁ + h₂ + h₃)⁴ | (h₂ + h₃)⁴ | h₃⁴ | h₃⁴ | (h₃ + h₄)⁴ |
| s₄ | (h₁ + h₂ + h₃ + h₄)⁴ | ( h₂ + h₃ + h₄)⁴ | (h₃ + h₄)⁴ | h₄⁴ | h₄⁴ |
| X̅ | $[ \begin{matrix}b \\ c \\ d \\ e\end{matrix} ]$ | $[ \begin{matrix}a \\ c \\ d \\ e\end{matrix} ]$ | $[ \begin{matrix}a \\ b \\ d \\ e\end{matrix} ]$ | $[ \begin{matrix}a \\ b \\ c \\ e\end{matrix} ]$ | $[ \begin{matrix}a \\ b \\ c \\ d\end{matrix} ]$ |
| a, | a = −(b + c + d + e) | b = −(a + c + d + e) | c = −(a + b + d + e) | d = −(a + b + c + e) | e = −(a + b + c + d) |
| b, | | | | | |
| c, | | | | | |
| d, | | | | | |
| or | | | | | |
| e | | | | | |
| p′ | a p(t₁) | a p(t₁) | a p(tⱼ₋₂) | a p(tₙ₋₄) | a p(tₙ₋₄) |
| | + b p(t₂) | + b p(t₂) | + b p(tⱼ₋₁) | + b p(tₙ₋₃) | + b p(tₙ₋₃) |
| | + c p(t₃) | + c p(t₃) | + c p(tⱼ) | + c p(tₙ₋₂) | + c p(tₙ₋₂) |
| | + d p(t₄) | + d p(t₄) | +d p(tⱼ₊₁) | + d p(tₙ₋₁) | + d p(tₙ₋₁) |
| | + e p(t₅) | + e p(t₅) | +e p(tⱼ₊₂) | + e p(tₙ) | + e p(tₙ) |

TABLE 4
Parameters for Second-Order Derivatives at Every Chronological Point

| | | | Evaluate | | |
|---|---|---|---|---|---|
| | Evaluate | Evaluate | p″(tⱼ) when | Evaluate | Evaluate |
| | p″(t₁) | p″(t₂) | 3 ≤ j ≤ n − 2 | p″(tₙ₋₁) | p″(tₙ) |
| p₁ | h₁ | −h₁ | −(h₁ + h₂) | −(h₁ + h₂ + h₃) | (h₁ + h₂ + h₃ + h₄) |
| q₁ | h₁ + h₂ | h₂ | −h₂ | −(h₂ + h₃) | h₂ + h₃ + h₄ |
| r₁ | h₁ + h₂ + h₃ | h₂ + h₃ | h₃ | −h₃ | h₃ + h₄ |
| s₁ | h₁ + h₂ + h₃ + h₄ | h₂ + h₃ + h₄ | h₃ + h₄ | h₄ | h₄ |
| p₂ | h₁² | h₁² | (h₁ + h₂)² | (h₁ + h₂ + h₃)² | (h₁ + h₂ + h₃ + h₄)² |
| q₂ | (h₁ + h₂)² | h₂² | h₂² | (h₂ + h₃)² | ( h₂ + h₃ + h₄)² |
| r₂ | (h₁ + h₂ + h₃)² | (h₂ + h₃)² | h₃² | h₃² | (h₃ + h₄)² |
| s₂ | (h₁ + h₂ + h₃ + h₄)² | ( h₂ + h₃ + h₄)² | (h₃ + h₄)² | h₄² | h₄² |
| p₃ | h₁³ | −h₁³ | −(h₁ + h₂)³ | −(h₁ + h₂ + h₃)³ | (h₁ + h₂ + h₃ + h₄)³ |
| q₃ | (h₁ + h₂)³ | h₂³ | −h₂³ | −(h₂ + h₃)³ | (h₂ + h₃ + h₄)³ |
| r₃ | (h₁ + h₂ + h₃)³ | (h₂ + h₃)³ | h₃³ | −h₃³ | (h₃ + h₄)³ |
| s₃ | (h₁ + h₂ + h₃ + h₄)³ | (h₂ + h₃ + h₄)³ | (h₃ + h₄)³ | h₄³ | h₄³ |
| p₄ | h₁⁴ | h₁⁴ | (h₁ + h₂)⁴ | (h₁ + h₂ + h₃)⁴ | (h₁ + h₂ + h₃ + h₄)⁴ |
| q₄ | (h₁ + h₂)⁴ | h₂⁴ | h₂⁴ | (h₂ + h₃)⁴ | ( h₂ + h₃ + h₄)⁴ |
| r₄ | (h₁ + h₂ + h₃)⁴ | (h₂ + h₃)⁴ | h₃⁴ | h₃⁴ | (h₃ + h₄)⁴ |
| s₄ | (h₁ + h₂ + h₃ + h₄)⁴ | ( h₂ + h₃ + h₄)⁴ | (h₃ + h₄)⁴ | h₄⁴ | h₄⁴ |
| X̅ | $[ \begin{matrix}b \\ c \\ d \\ e\end{matrix} ]$ | $[ \begin{matrix}a \\ c \\ d \\ e\end{matrix} ]$ | $[ \begin{matrix}a \\ b \\ d \\ e\end{matrix} ]$ | $[ \begin{matrix}a \\ b \\ c \\ e\end{matrix} ]$ | $[ \begin{matrix}a \\ b \\ c \\ d\end{matrix} ]$ |
| a, | a = −(b + c + d + e) | b = −(a + c + d + e) | c = −(a + b + d + e) | d = −(a + b + c + e) | e = −(a + b + c + d) |
| b, | | | | | |
| c, | | | | | |
| d, | | | | | |
| or | | | | | |
| e | | | | | |
| p″ | a p(t₁) | a p(t₁) | a p(tⱼ₋₂) | a p(tₙ₋₄) | a p(tₙ₋₄) |
| | + b p(t₂) | + b p(t₂) | + b p(tⱼ₋₁) | + b p(tₙ₋₃) | + b p(tₙ₋₃) |
| | + c p(t₃) | + c p(t₃) | + c p(tⱼ) | + c p(tₙ₋₂) | + c p(tₙ₋₂) |
| | + d p(t₄) | + d p(t₄) | +d p(tⱼ₊₁) | + d p(tₙ₋₁) | + d p(tₙ₋₁) |
| | + e p(t₅) | + e p(t₅) | +e p(tⱼ₊₂) | + e p(tₙ) | + e p(tₙ) |

The numerical evaluation of vector X̅ at each focal point provides four of the five coefficients (a, b, c, d, and e), as shown in the third last rows of Tables 3 and 4 for both types of derivatives. This is achieved through the corresponding appropriate, long-form expressions, which are presented as four elements of vector X̅ in Table 5. The unsolved fifth coefficient (a, b, c, d, or e) is found from Equation (3), for each focal point, and is presented in second last rows of Tables 3 and 4 for the respective type of derivatives. The final steps of computing individual types of derivatives (p′ and p″) at all types of focal points are accomplished with the equations presented in the last rows of Tables 3 and 4.

TABLE 5
Expressions for Final Solutions to Unknown Coefficients in Vector, X̅.

| Type of | | |
|---|---|---|
| Derivatives | Symbol | Expression in Terms of Known Parameters |
| p′ | X̅ | $[ \begin{matrix}( {q}_{2} {r}_{3} {s}_{4} - {q}_{2} {r}_{4} {s}_{3} - {q}_{3} {r}_{2} {s}_{4} + {q}_{3} {r}_{4} {s}_{2} + {q}_{4} {r}_{2} {s}_{3} - {q}_{4} {r}_{3} {s}_{2} ) / D - \\ ( {p}_{2} {r}_{3} {s}_{4} - {p}_{2} {r}_{4} {s}_{3} - {p}_{3} {r}_{2} {s}_{4} + {p}_{3} {r}_{4} {s}_{2} + {p}_{4} {r}_{2} {s}_{3} - {p}_{4} {r}_{3} {s}_{2} ) / D \\ ( {p}_{2} {q}_{3} {s}_{4} - {p}_{2} {q}_{4} {s}_{3} - {p}_{3} {q}_{2} {s}_{4} + {p}_{3} {q}_{4} {s}_{2} + {p}_{4} {q}_{3} {s}_{3} - {p}_{4} {q}_{3} {s}_{2} ) / D - \\ ( {p}_{2} {q}_{3} {r}_{4} - {p}_{2} {q}_{4} {r}_{3} - {p}_{3} {q}_{2} {r}_{4} + {p}_{3} {q}_{4} {r}_{2} + {p}_{4} {q}_{2} {r}_{3} - {p}_{4} {q}_{3} {r}_{2} ) / D\end{matrix} ]$ |
| p″ | X̅ | $[ \begin{matrix}- 2 ( {q}_{1} {r}_{3} {s}_{4} - {q}_{1} {r}_{4} {s}_{3} - {q}_{3} {r}_{1} {s}_{4} + {q}_{3} {r}_{4} {s}_{1} + {q}_{4} {r}_{1} {s}_{3} - {q}_{4} {r}_{3} {s}_{1} ) / D \\ 2 ( {p}_{1} {r}_{3} {s}_{4} - {p}_{1} {r}_{4} {s}_{3} - {p}_{3} {r}_{1} {s}_{4} + {p}_{3} {r}_{4} {s}_{1} + {p}_{4} {r}_{1} {s}_{3} - {p}_{4} {r}_{3} {s}_{1} ) / D - \\ 2 ( {p}_{1} {q}_{3} {s}_{4} - {p}_{1} {q}_{4} {s}_{3} - {p}_{3} {q}_{1} {s}_{4} + {p}_{3} {q}_{4} {s}_{1} + {p}_{4} {q}_{1} {s}_{3} - {p}_{4} {q}_{3} {s}_{1} ) / D \\ 2 ( {p}_{1} {q}_{3} {r}_{4} - {p}_{1} {q}_{4} {r}_{3} - {p}_{3} {q}_{1} {r}_{4} + {p}_{3} {q}_{4} {r}_{1} + {p}_{4} {q}_{1} {r}_{3} - {p}_{4} {q}_{3} {r}_{1} ) / D\end{matrix} ]$ |
| p′ and p″ | D | p₁q₂r₃s₄ − p₁q₂r₄s₃ − p₁q₃r₂s₄ + p₁q₃r₄s₂ + p₁q₄r₂s₃ − |
| | | p₁q₄r₃s₂ − p₂q₁r₃s₄ + p₂q₁r₄s₃ + p₂q₃r₁s₄ − |
| | | p₂q₃r₄s₁ − p₂q₄r₁s₃ + p₂q₄r₃s₁ + p₃q₁r₂s₄ − |
| | | p₃q₁r₄s₂ − p₃q₂r₁s₄ + p₃q₂r₄s₁ + p₃q₄r₁s₂ − |
| | | p₃q₄r₂s₁ − p₄q₁r₂s₃ + p₄q₁r₃s₂ + p₄q₂r₁s₃ − |
| | | p₄q₂r₃s₁ − p₄q₃r₁s₂ + p₄q₃r₂s₁ |

In Table 5, D is a long-form expression for computing elements of X̅.

The equations presented above are systematically classified into five groups depending on the locations of the focal points so that the corresponding computations progress regularly and the derivative profiles appear flawlessly. Four of these groups belong to the terminal points (1, 2, n−1, and n), and the other one belongs to the intermediate points with j, for 3≤j≤n−2. The core approach with the five-point representation of pressure derivatives of both first-order and second-order derivatives has been adopted evenly for the intermediate points with j, for 3≤j≤n−2. This means that point j can be any point in the data set, except the terminal points (1, 2, n−1, and n). The computations at the terminal points (1, 2, n−1, and n) have been treated to correct for any end effects due to the less than balanced supply of information around a focal point while representing pressure derivatives of both first and second orders with five neighboring pressure points. Presentation of the algorithm with equations and expressions in Tables 1 through 5 demonstrates efficient handling of the computational load due to the representation of each of type of derivatives with five consecutive pressure values in the data set.

### Algorithms for Computing Derivatives

The previous section presented a detailed computational procedure in extracting derivative values at each data point in a data set. This section presents algorithms to direct how the process moves along from one step to another to get to the final destination of reaching the computed values of derivatives. Such algorithms can be used when dealing with hundreds or thousands of data points in a data set to manage the computational load and to perform the computations efficiently. A derivative calculator can be generated for providing derivative values at a given point, and derivative profiles with all the calculated derivative values.

### Building a Derivative Calculator

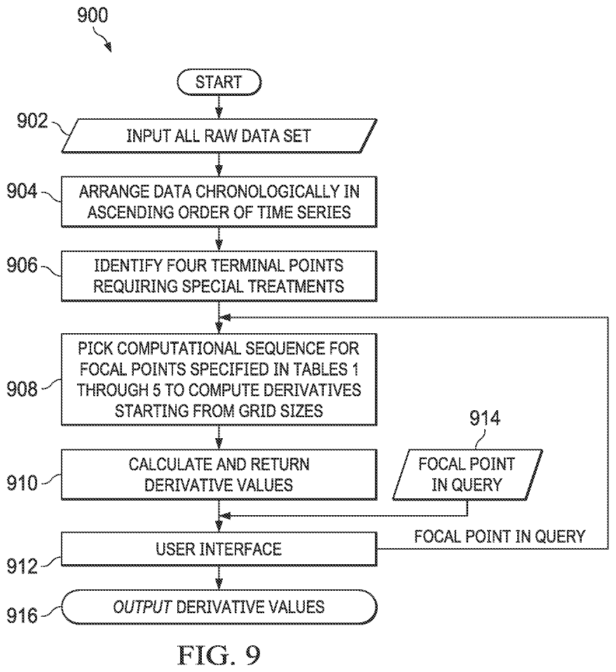

FIG. 9 is a diagram showing an example of a workflow 900 of a derivative calculator, according to some implementations of the present disclosure. At 902, the derivative calculator can receive and use raw data input. At 904, the data can be arranged or sorted in chronologically ascending order of a time series. At 906, four terminal data points requiring special treatment can be identified. For example, except for the four terminal points, intermediate points are subject to the core five-point computational procedure. At 908, the derivative calculator can choose one of the five tracks of a computational sequence depending on the data point to be used in calculations. At 910, the derivative calculator can compute the derivatives. At 912, a user interface can accept a request (for example, identifying a focal point 914) for computing derivatives at one point at a time, for output 916.

### Grand Algorithm for Computing Derivatives and Presenting Profiles

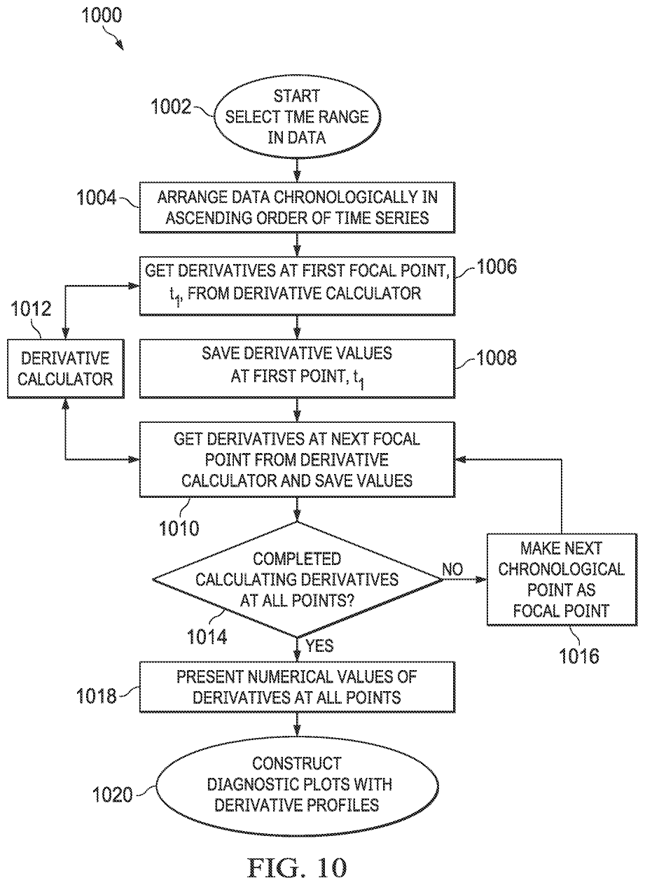

This grand algorithm (GA) can put together all the key elements and coordinates the entire process of calculating derivatives at each point in the data set and present the profiles of derivatives as shown in FIG. 10. The derivative calculator is also a major component within the GA.

FIG. 10 is a diagram showing an example of a grand algorithm (GA) 1000 using input raw data to generate derivative profiles, according to some implementations of the present disclosure. The GA 1000 can deploy the derivative calculator to calculate the derivatives at one focal point at a time, and store the results. Once the derivatives at all the successive focal points have been calculated, the numerical values are available for constructing specialized derivative profiles. Construction of specialized derivative profiles are discussed in the next section.

At 1002, a time range in the data is selected. At 1004, the data points are arranged in chronological order. At 1006, the derivative at t₁ is determined by the derivative calculator. At 1008, the derivative values at t₁ are saved. At 1010, derivatives at the next focal point are obtained and the values are saved. At 1012, if more values are to be computed, then step 1006 is re-executed. At 1014, a check is made whether the calculating derivative at all points has been completed. If not, then at 1016, the next chronological point is designated as the next focal point, and step 1010 is repeated. At 1018, the numerical values of derivatives of all points are presented. At 1020, diagnostic plots are constructed using the derivative profiles.

### First-Order Derivative Profiles

The first-order derivatives of pressure with respect to time be used to determine the conventional well-test derivatives (commonly known as Bourdet derivatives) as shown below:

For a Single-Rate Test:

$$Well - Test Derivative at Point j = {{t}_{j} ( \frac{dp}{dt} )}_{j} = {t}_{j} {p}^{′} ( {t}_{j} ) = {( \frac{dp}{dT} )}_{j} = {p}^{′} ( {T}_{j} ) \qquad ( 4 )$$

where p′(tⱼ) or

$${( \frac{dp}{dt} )}_{j}$$

is the first-order derivative or primary pressure derivative at point j with respect to time. Equation (4) also shows that the first-order derivative in a single-rate test leads to the well-test derivative when differentiated with respect to the superposition time function, T.

For a Multi-Rate Test:

$$Well - Test Derivative at Point j = {( \frac{dp}{dT} )}_{j} = {p}^{′} ( {T}_{j} ) \qquad ( 5 )$$

where p′(Tⱼ) or

$${( \frac{dp}{dT} )}_{j}$$

is the first-order derivative at point j with respect to the superposition time function.

Notice that the well-test derivative requires multiplication of the first-order derivative by time (tⱼ). However, for multi-rate tests, the first-order derivative equals the well-test derivative because of the superposition time function, T. This is also true in single-rate tests when taken with respect to the superposition time function.

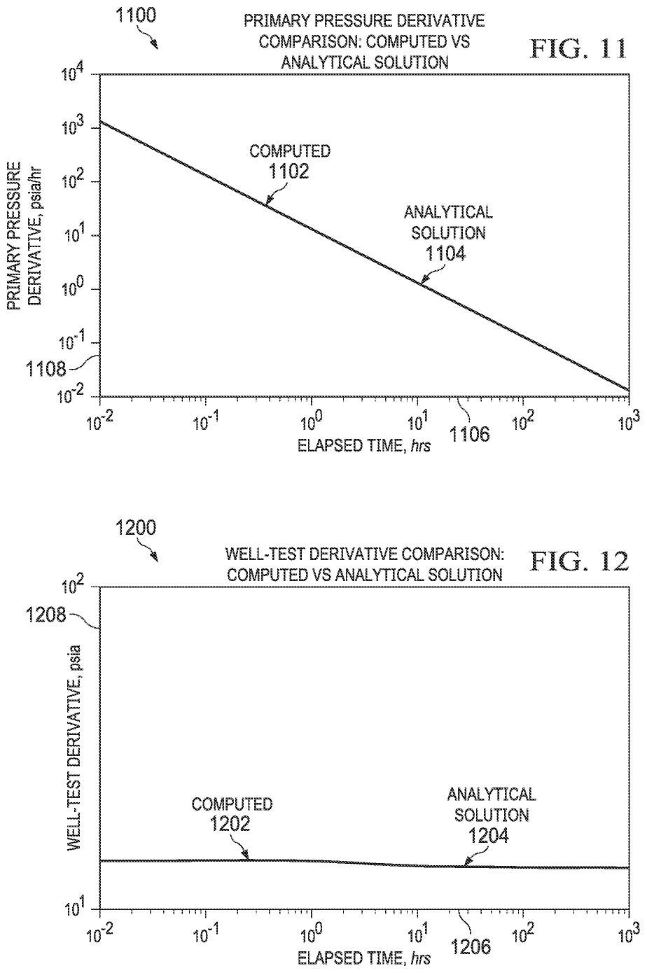

FIG. 11 is a diagram showing an example of a graph 1100 showing a comparison of computed primary pressure derivatives 1102 with respective values of analytical solution derivatives 1104 (exact values), according to some implementations of the present disclosure. FIG. 11 shows a comparison of the primary pressure derivatives (p′(tⱼ)) 1102 calculated from discrete pressure points to the derivatives 1104 from an ideal analytical solution on a log-log plane. The derivatives are plotted relative to an elapsed time axis 1106 (for example, in hrs) and a primary pressure derivative 1108 (for example, in psia/hr). This demonstrates that computations of the first-order derivatives are accurate enough to match the corresponding exact values of the analytical solution. Also notice that there are no end effects in the computed values of the derivatives, and these all match the values of the analytical solution.

FIG. 12 is a diagram showing an example of a graph 1200 showing a comparison of computed well-test derivatives 1202 to the respective values of analytical solution derivatives 1204 (exact values), according to some implementations of the present disclosure. FIG. 12 presents a comparison of computed well-test derivatives out of discrete data points to those determined from an analytical solution on a log-log plane. These derivatives are the first-order derivatives with respect to the superposition time function for a single-rate test as shown in Equation (4). The plots are shown relative to an elapsed time axis 1206 (for example, in hrs) and a well-test pressure derivative 1208. The comparison demonstrates the accuracy of the constructed derivative profile with no distorted end effects. Although the well is located 300 feet (ft) away from low-grade reservoir heterogeneity with a 10% increase in permeability, this phenomenon is not prominent in the derivative profile of FIG. 12.

### Second-Order Derivative Profiles

For a Single-Rate Test:

$$Dual Derivative at Point j = {{t}_{j}^{2} ( \frac{{d}^{2} p}{{dt}^{2}} )}_{j} = {t}_{j}^{2} {p}^{′′} ( {t}_{j} ) \qquad ( 6 )$$

where p″(tⱼ) or

$${( \frac{{d}^{2} p}{{dt}^{2}} )}_{j}$$

is the second-order derivative at point j with respect to time.

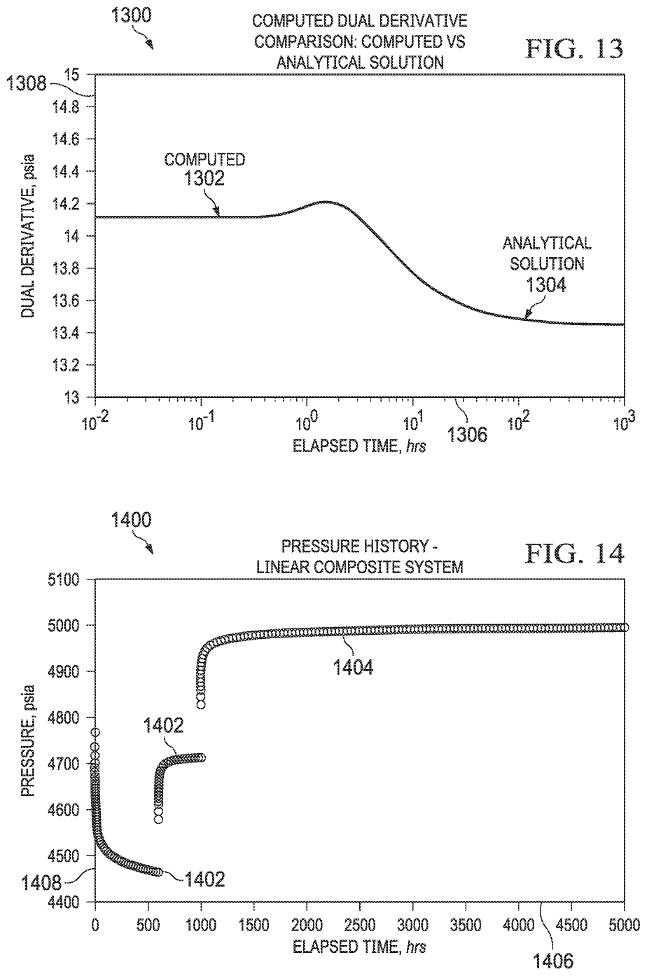

FIG. 13 is a diagram illustrating an example of a graph 1300 showing a comparison of computed dual derivatives 1302 to the respective values of analytical solution derivatives 1304 (exact values), according to some implementations of the present disclosure. FIG. 13 presents a comparison of computed dual derivatives out of discrete data points to derivatives determined from an analytical solution on a semi-log plane. The plots are shown relative to an elapsed time axis 1306 (for example, in hrs) and a well-test pressure derivative 1308. These derivatives utilize the second-order derivatives with respect to time for a single-rate test as shown in Equation (6). The comparison demonstrates the accuracy of the constructed derivative profile with no signs of distorted end effects. As the well is located 300 feet away from low-grade reservoir heterogeneity with a 10% increase in permeability, this phenomenon is prominent with a hump at around one hour in the derivative profile of FIG. 13. In contrast, this phenomenon is not prominent in the well-test derivative profile of FIG. 12. This provides proof that dual derivatives are more sensitive to a low-grade reservoir heterogeneity than well-test derivatives. As such, the dual derivatives can become superior diagnostic tools in investigating low-grade reservoir heterogeneity. The present disclosure facilitates the procedure of calculating the second-derivatives in general, and the dual derivatives in particular.

For a multi-rate test, although the apparent definition of the dual derivative is the same as that for the single-rate test (Equation (6)), the evaluation of these values requires computations of dual derivatives with respect to the superposition time function, T, in addition to the well-test derivatives as shown below:

$$Dual Derivative at Point j = {{t}_{j}^{2} ( \frac{{d}^{2} p}{{dt}^{2}} )}_{j} = {( \frac{dp}{DT} )}_{j} - {( \frac{{d}^{2} p}{{dT}^{2}} )}_{j} = {p}^{′} ( {T}_{j} ) - {p}^{′′} ( {T}_{j} ) \qquad ( 7 )$$

where p″(Tⱼ) or

$${( \frac{{d}^{2} p}{{dT}^{2}} )}_{j}$$

is the second-order derivative at point j with respect to the superposition time function. Computations of p″(Tⱼ) follow the same approach as for the one with respect to time, p″(tⱼ). Similarly, the computations of p′(Tⱼ), the well-test derivatives, are straightforward as demonstrated for the ones for the single-rate test. Therefore, computations of the dual derivatives, presented in Equation (7), require both first- and second-order derivatives of pressure with respect to superposition time function.

The superposition time function, T, at a given time, t, accounts for variations of N production or injection rates, and can be calculated in the following way when the final rate is zero (q_{N}=0)

$$T ( t ) = - \frac{1}{{q}_{N - 1}} {\sum }_{k = 1}^{N - 1} {q}_{k} ln ( \frac{t - {t}_{k - 1}}{t - {t}_{k}} ) \qquad ( 8 )$$

Note that the positive sign ahead of

$${( \frac{dp}{DT} )}_{j}$$

or p′(Tⱼ) and the negative sign ahead of

$${( \frac{{d}^{2} p}{{dT}^{2}} )}_{j}$$

or p″(Tⱼ) in Equation (7) have resulted from the negative sign in the definition of the superposition time function defined in Equation (8). Such a negative sign in the expression for the superposition time function makes the magnitudes of well-test derivatives positive. In a situation when the superposition time function does not account for the negative sign, the term,

$${( \frac{dp}{DT} )}_{j}$$

or p′(Tⱼ) in Equation (7), must be preceded by a negative sign. As such, the term

$${( \frac{{d}^{2} p}{{dT}^{2}} )}_{j}$$

or p″(Tⱼ) is to be preceded by a positive sign.

The rest of the discussion is related to an example of a multi-rate test in Well-A with two flow periods followed by a build-up period. Table 6 shows the production and shut-in schedule of the well located at 300 feet away from a low-grade reservoir heterogeneity with a 10% increase in permeability.

TABLE 6
Schedule of Production and Shut-in of Well-A

| | | | Production |
|---|---|---|---|
| | | | Rate, |
| | | | standard |
| | | | barrels |
| Chronological | Well | Duration, | per day |
| Sequence | Condition | hr | (STB/D) |
| 1 | Flow | 600 | 400 |
| 2 | Flow | 400 | 200 |
| 3 | Shut in | 4000 | 0 |

FIG. 14 is a diagram showing an example of a pressure history 1400 of a multi-rate test, according to some implementations of the present disclosure. The pressure history 1400 includes two flow periods 1402 followed by a build-up period 1404 in Well-A. Plots in the pressure history 1400 are plotted relative to an elapsed time 1406 (for example, in hours) and a pressure 1408 (for example, in psia). The multi-rate test involves different rates in its history over 5000 hrs as shown in Table 6. Since it is desired to investigate this well with dual derivatives, the superposition time function is to be calculated with Equation (8) all the way to 5000 hr.

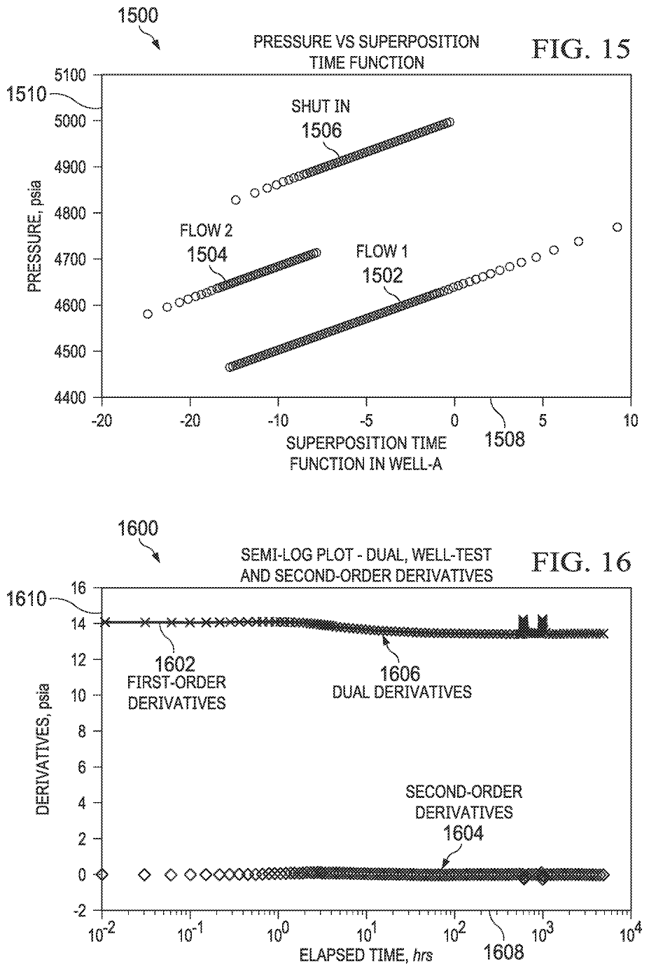

FIG. 15 is a diagram showing an example of a superposition time function 1500, according to some implementations of the present disclosure. The superposition time function 1500 provides comparative magnitudes of dual, first- and second-order derivatives in respective profiles in Well-A. The superposition time function is not continuous between the periods of any changes in the rate of production. For example, there is a discontinuity in the superposition time function between the end of the first flow period 1502 and the beginning of the second flow period 1504. There is also another discontinuity in between the end of the second flow period 1504 and the beginning of the shut-in period 1506. The time periods are plotted relative to a superposition time function 1508 and a pressure 1510 (for example, in psia). As presented in Equation (7), dual derivatives are the algebraic sum of the first- and the second-order derivatives of pressure with respect to the superposition time function. During a stable flow regime (for example, infinite-acting radial flow), the magnitudes of well-test derivatives (first-order derivatives of pressure with respect to the superposition time function) are constant, and the second-order derivatives of pressure with respect to the superposition time function (first-order derivatives of well-test derivatives with respect to the superposition time function) are zero. However, during any transition period between the stable flow regimes, the second-order derivatives of pressure with respect to the superposition time function are non-zero (positive or negative) and do stand out to manifest themselves as enhanced features in the derivative profiles. By manipulating this strength of the second-order derivatives of pressure with respect to the superposition time function as a component of the dual derivatives, the dual derivative profiles can be utilized as diagnostic tools for being sensitive to low-grade reservoir heterogeneity.

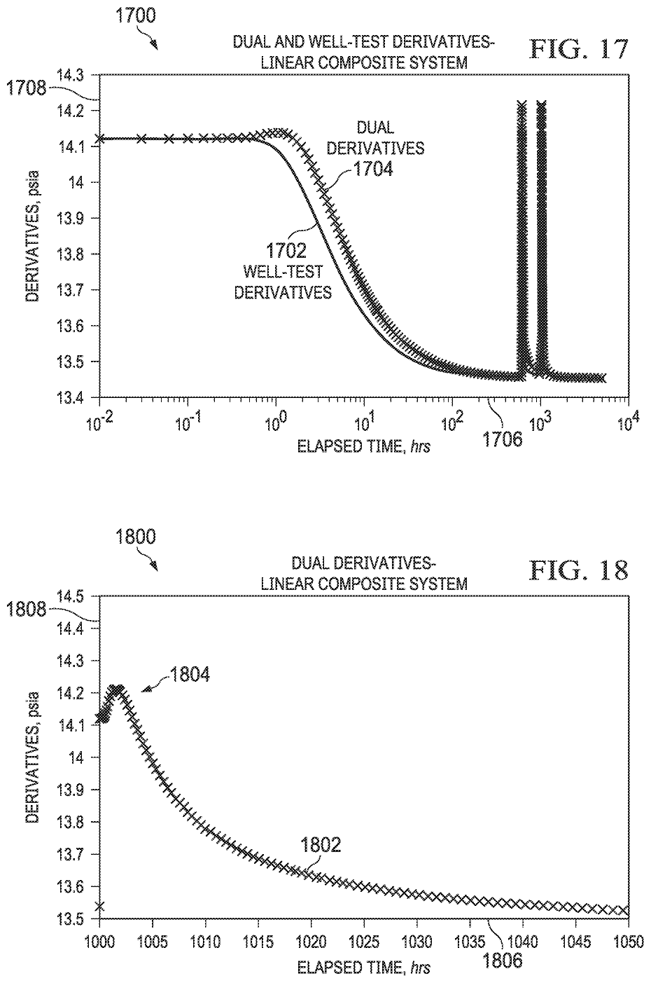

As suggested in the workflow of FIG. 2, the second-order derivatives are to be computed with respect to the superposition time function as one of the components in Equation (7). One needs to follow the multi-rate test procedure even to analyze the data of a build-up test. Three sets of derivative profiles are presented on a semi-log plane of FIG. 16.

FIG. 16 is a semi-log plot diagram showing an example of comparative magnitudes of dual, well-test and second-order derivatives in respective profiles, according to some implementations of the present disclosure. For example, FIG. 16 shows second-order derivatives 1604 with respect to superposition time function, dual derivatives 1606 with respect to time, and the well-test derivatives (first order derivatives 1602) in Well-A. All three profiles report spikes at the two junctions of periods at the locations of discontinuity of the superposition time function as discussed earlier. The profiles are plotted relative to elapsed time 1608 (for example, in hrs) and derivatives 1610 (for example, in psia). Due to a presentation in a large scale in FIG. 16, it is difficult to distinguish between the dual derivatives 1606 and the well-test derivatives (first order derivatives 1602). To alleviate the situation, FIG. 17 presents these two sets of derivatives on a semi-log plane.

FIG. 17 is a diagram 1700 showing an example of comparative magnitudes of dual and well-test derivatives in respective profiles, according to some implementations of the present disclosure. For example, FIG. 17 shows an example of a hump in response to a low-grade reservoir heterogeneity in the dual derivative profile 1704 during the first flow period in Well-A. This demonstrates the advantage of having the dual derivative profiles over the well-test derivative profile 1702. The profiles are plotted relative to elapsed time 1706 (for example, in hrs, in a log scale) and derivatives 1708 (for example, in psia). The spikes appearing at 600 hrs and 1000 hrs are due to the discontinuity in the superposition time function for the respective rate changes as discussed earlier.

FIG. 18 is a diagram 1800 showing an example of a zoomed-in view of dual derivative profile 1802 during an early time into shut-in period, according to some implementations of the present disclosure. FIG. 18 can be used to observe the impact of the low-grade reservoir heterogeneity during the shut-in period in Well-A, in which a zoomed view is presented. The profiles are plotted relative to elapsed time 1806 (for example, in hrs) and derivatives 1808 (for example, in psia). A hump 1804 has appeared after one hour into the shut-in period, demonstrating the sensitivity of the dual derivatives to reservoir heterogeneity. This demonstrates that dual derivative profile is capable of diagnosing low-grade reservoir heterogeneity from both flow and build-up tests.

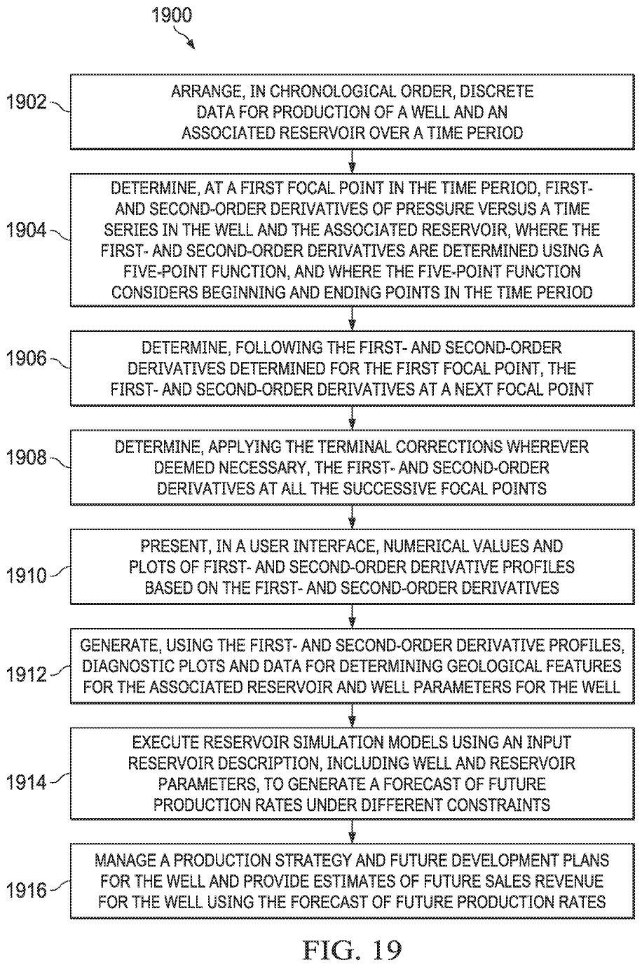

FIG. 19 is a flowchart of an example of a method 1900 for constructing and using first- and second-order derivatives from discrete pressure data of a well to characterize the well and the contacted reservoir under dynamic conditions, according to some implementations of the present disclosure. For clarity of presentation, the description that follows generally describes method 1900 in the context of the other figures in this description. However, it will be understood that method 1900 can be performed, for example, by any suitable system, environment, software, and hardware, or a combination of systems, environments, software, and hardware, as appropriate. In some implementations, various steps of method 1900 can be run in parallel, in combination, in loops, or in any order.

At 1902, discrete data for production of a well and an associated reservoir are arranged in chronological order over a time period. The well can be, for example, an oil well, a gas well, or a water well. The discrete includes, for example, well pressure versus time, production/injection versus time, petrophysical parameters, and rock and fluid properties. The arranged discrete data can correspond, for example, to data collected in step 202 of workflow 200, for example. From 1902, method 1900 proceeds to 1904.

At 1904, first- and second-order derivative of pressure versus a time series in the well and the associated reservoir are determined at a first focal point in the time period. The first- and second-order derivatives are saved. The first- and second-order derivatives are determined using a five-point function. The five-point function considers beginning and ending points in the time period. The derivatives can be determined as described with reference to FIGS. 3 and 4, for example. From 1904, method 1900 proceeds to 1906.

At 1906, first- and second-order derivatives at a next (second) focal point are determined and saved following the first- and second-order derivatives determined for the first focal point. The derivatives can be determined as described with reference to FIGS. 3 and 5, for example. From 1906, method 1900 proceeds to 1908.

At 1908, the first- and second-order derivatives at all successive focal points are determined (for example, applying the terminal corrections wherever deemed necessary) and saved. The derivatives can be determined as described with reference to FIGS. 3 and 6 through 8, for example. From 1908, method 1900 proceeds to 1910.

At 1910, presenting, in a user interface, numerical values and plots of first- and second-order derivative profiles based on the first- and second-order derivatives. From 1910, method 1900 proceeds to 1912.

At 1912, generating, using the first- and second-order derivative profiles, diagnostic plots and data for determining geological features for the associated reservoir and well parameters for the well. From 1912, method 1900 proceeds to 1914.

At 1914, reservoir simulation models are executed using an input reservoir description, including well and reservoir parameters, to generate a forecast of future production rates under different constraints. Investigated scenarios of higher hydrocarbon (oil and gas) output potential may require additional investments in drilling infill wells, and building production infrastructure, handling facilities, processing plants and shipment facilities of fluids. Such field development plans must be justified by the expanded, incremental economics with additional hydrocarbon output and the revenues thereof. Only reliable simulation models built with reliable input parameters can provide reliable hydrocarbon production forecasts. From 1914, method 1900 proceeds to 1916.

At 1916, a production strategy and future development plans for the well are managed, and estimates of future sales revenue for the well are provided using the forecast of future production rates. Reservoir engineers routinely review the field performance to maximize the recovery of the hydrocarbons (oil and gas) in the reservoir. Production strategy can and does change in different parts of the field with time in response to any changes in local dynamics in the reservoir. Reservoir engineers rely highly on the output of reservoir simulation models in monitoring the fluid dynamics in their field by comparing the actual production to the predicted production. In addition, future production rates are utilized in forecasting sales revenues as part of economic analyses. Generating any additional revenues through sales can require additional investments which must be justified by the field operator's economic parameters, for example, the net present value, the discounted cash flow, the internal rate of return, the payback period, and so on. After 1916, method 1900 can stop.

In some implementations, in addition to (or in combination with) any previously-described features, techniques of the present disclosure can include the following. Customized user interfaces can present intermediate or final results of the above described processes to a user. The presented information can be presented in one or more textual, tabular, or graphical formats, such as through a dashboard. The information can be presented at one or more on-site locations (such as at an oil well or other facility), on the Internet (such as on a webpage), on a mobile application (or “app”), or at a central processing facility. The presented information can include suggestions, such as suggested changes in parameters or processing inputs, that the user can select to implement improvements in a production environment, such as in the exploration, production, and/or testing of petrochemical processes or facilities. For example, the suggestions can include parameters that, when selected by the user, can cause a change or an improvement in drilling parameters (including speed and direction) or overall production of a gas or oil well. The suggestions, when implemented by the user, can improve the speed and accuracy of calculations, streamline processes, improve models, and solve problems related to efficiency, performance, safety, reliability, costs, downtime, and the need for human interaction. In some implementations, the suggestions can be implemented in real-time, such as to provide an immediate or near-immediate change in operations or in a model. The term real-time can correspond, for example, to events that occur within a specified period of time, such as within one minute or within one second. In some implementations, values of parameters or other variables that are determined can be used automatically (such as through using rules) to implement changes in oil or gas well exploration, production/drilling, or testing. For example, outputs of the present disclosure can be used as inputs to other equipment and/or systems at a facility. This can be especially useful for systems or various pieces of equipment that are located several meters or several miles apart, or are located in different countries or other jurisdictions.

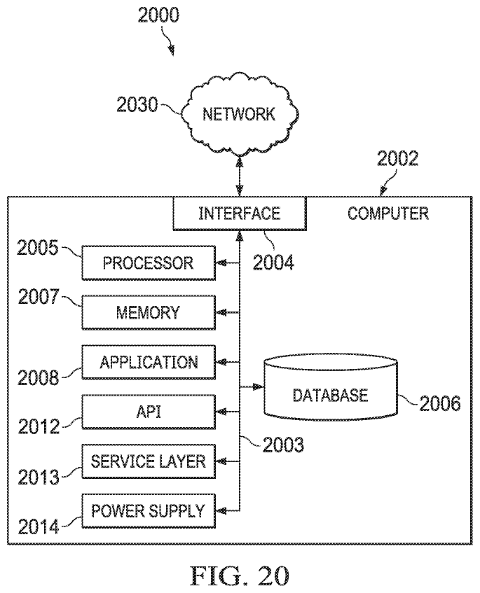

FIG. 20 is a block diagram of an example computer system 2000 used to provide computational functionalities associated with described algorithms, methods, functions, processes, flows, and procedures described in the present disclosure, according to some implementations of the present disclosure. The illustrated computer 2002 is intended to encompass any computing device such as a server, a desktop computer, a laptop/notebook computer, a wireless data port, a smart phone, a personal data assistant (PDA), a tablet computing device, or one or more processors within these devices, including physical instances, virtual instances, or both. The computer 2002 can include input devices such as keypads, keyboards, and touch screens that can accept user information. Also, the computer 2002 can include output devices that can convey information associated with the operation of the computer 2002. The information can include digital data, visual data, audio information, or a combination of information. The information can be presented in a graphical user interface (UI) (or GUI).

The computer 2002 can serve in a role as a client, a network component, a server, a database, a persistency, or components of a computer system for performing the subject matter described in the present disclosure. The illustrated computer 2002 is communicably coupled with a network 2030. In some implementations, one or more components of the computer 2002 can be configured to operate within different environments, including cloud-computing-based environments, local environments, global environments, and combinations of environments.

At a top level, the computer 2002 is an electronic computing device operable to receive, transmit, process, store, and manage data and information associated with the described subject matter. According to some implementations, the computer 2002 can also include, or be communicably coupled with, an application server, an email server, a web server, a caching server, a streaming data server, or a combination of servers.

The computer 2002 can receive requests over network 2030 from a client application (for example, executing on another computer 2002). The computer 2002 can respond to the received requests by processing the received requests using software applications. Requests can also be sent to the computer 2002 from internal users (for example, from a command console), external (or third) parties, automated applications, entities, individuals, systems, and computers.

Each of the components of the computer 2002 can communicate using a system bus 2003. In some implementations, any or all of the components of the computer 2002, including hardware or software components, can interface with each other or the interface 2004 (or a combination of both) over the system bus 2003. Interfaces can use an application programming interface (API) 2012, a service layer 2013, or a combination of the API 2012 and service layer 2013. The API 2012 can include specifications for routines, data structures, and object classes. The API 2012 can be either computer-language independent or dependent. The API 2012 can refer to a complete interface, a single function, or a set of APIs.

The service layer 2013 can provide software services to the computer 2002 and other components (whether illustrated or not) that are communicably coupled to the computer 2002. The functionality of the computer 2002 can be accessible for all service consumers using this service layer. Software services, such as those provided by the service layer 2013, can provide reusable, defined functionalities through a defined interface. For example, the interface can be software written in JAVA, C++, or a language providing data in extensible markup language (XML) format. While illustrated as an integrated component of the computer 2002, in alternative implementations, the API 2012 or the service layer 2013 can be stand-alone components in relation to other components of the computer 2002 and other components communicably coupled to the computer 2002. Moreover, any or all parts of the API 2012 or the service layer 2013 can be implemented as child or sub-modules of another software module, enterprise application, or hardware module without departing from the scope of the present disclosure.

The computer 2002 includes an interface 2004. Although illustrated as a single interface 2004 in FIG. 20, two or more interfaces 2004 can be used according to particular needs, desires, or particular implementations of the computer 2002 and the described functionality. The interface 2004 can be used by the computer 2002 for communicating with other systems that are connected to the network 2030 (whether illustrated or not) in a distributed environment. Generally, the interface 2004 can include, or be implemented using, logic encoded in software or hardware (or a combination of software and hardware) operable to communicate with the network 2030. More specifically, the interface 2004 can include software supporting one or more communication protocols associated with communications. As such, the network 2030 or the interface's hardware can be operable to communicate physical signals within and outside of the illustrated computer 2002.

The computer 2002 includes a processor 2005. Although illustrated as a single processor 2005 in FIG. 20, two or more processors 2005 can be used according to particular needs, desires, or particular implementations of the computer 2002 and the described functionality. Generally, the processor 2005 can execute instructions and can manipulate data to perform the operations of the computer 2002, including operations using algorithms, methods, functions, processes, flows, and procedures as described in the present disclosure.

The computer 2002 also includes a database 2006 that can hold data for the computer 2002 and other components connected to the network 2030 (whether illustrated or not). For example, database 2006 can be an in-memory, conventional, or a database storing data consistent with the present disclosure. In some implementations, database 2006 can be a combination of two or more different database types (for example, hybrid in-memory and conventional databases) according to particular needs, desires, or particular implementations of the computer 2002 and the described functionality. Although illustrated as a single database 2006 in FIG. 20, two or more databases (of the same, different, or combination of types) can be used according to particular needs, desires, or particular implementations of the computer 2002 and the described functionality. While database 2006 is illustrated as an internal component of the computer 2002, in alternative implementations, database 2006 can be external to the computer 2002.

The computer 2002 also includes a memory 2007 that can hold data for the computer 2002 or a combination of components connected to the network 2030 (whether illustrated or not). Memory 2007 can store any data consistent with the present disclosure. In some implementations, memory 2007 can be a combination of two or more different types of memory (for example, a combination of semiconductor and magnetic storage) according to particular needs, desires, or particular implementations of the computer 2002 and the described functionality. Although illustrated as a single memory 2007 in FIG. 20, two or more memories 2007 (of the same, different, or combination of types) can be used according to particular needs, desires, or particular implementations of the computer 2002 and the described functionality. While memory 2007 is illustrated as an internal component of the computer 2002, in alternative implementations, memory 2007 can be external to the computer 2002.

The application 2008 can be an algorithmic software engine providing functionality according to particular needs, desires, or particular implementations of the computer 2002 and the described functionality. For example, application 2008 can serve as one or more components, modules, or applications. Further, although illustrated as a single application 2008, the application 2008 can be implemented as multiple applications 2008 on the computer 2002. In addition, although illustrated as internal to the computer 2002, in alternative implementations, the application 2008 can be external to the computer 2002.

The computer 2002 can also include a power supply 2014. The power supply 2014 can include a rechargeable or non-rechargeable battery that can be configured to be either user- or non-user-replaceable. In some implementations, the power supply 2014 can include power-conversion and management circuits, including recharging, standby, and power management functionalities. In some implementations, the power-supply 2014 can include a power plug to allow the computer 2002 to be plugged into a wall socket or a power source to, for example, power the computer 2002 or recharge a rechargeable battery.

There can be any number of computers 2002 associated with, or external to, a computer system containing computer 2002, with each computer 2002 communicating over network 2030. Further, the terms “client,” “user,” and other appropriate terminology can be used interchangeably, as appropriate, without departing from the scope of the present disclosure. Moreover, the present disclosure contemplates that many users can use one computer 2002 and one user can use multiple computers 2002.

Described implementations of the subject matter can include one or more features, alone or in combination.

For example, in a first implementation, a computer-implemented method includes the following. Discrete data for production of a well and an associated reservoir are arranged in chronological order over a time period. First- and second-order derivatives of pressure versus a time series in the well and the associated reservoir are determined at a first focal point in the time period. The first- and second-order derivatives are determined using a five-point function. The five-point function considers beginning and ending points in the time period. The first- and second-order derivatives are determined at a next focal point following the determination of the first- and second-order derivatives for the first focal point. The first- and second-order derivatives are determined at all the successive focal points, applying the terminal corrections wherever deemed necessary. Numerical values and plots of first- and second-order derivative profiles that are based on the first- and second-order derivatives are presented in a user interface. Diagnostic plots and data for determining geological features for the associated reservoir and well parameters for the well are generated using the first- and second-order derivative profiles. Reservoir simulation models are executed using an input reservoir description, including well and reservoir parameters, to generate a forecast of future production rates under different constraints. A production strategy and future development plans for the well are managed, and estimates of future sales revenue for the well are provided using the forecast of future production rates.

The foregoing and other described implementations can each, optionally, include one or more of the following features:

A first feature, combinable with any of the following features, where the discrete data includes: well pressure versus time, production/injection versus time, petrophysical parameters, and rock and fluid properties.

A second feature, combinable with any of the previous or following features, where the well is an oil well, a gas well, or a water well.

A third feature, combinable with any of the previous or following features, the method further including combining data obtained from drill-stem tests of the well with fluid production and injection rates and rock and fluid properties; and characterizing the well and a completed reservoir of the well using the combined data.

A fourth feature, combinable with any of the previous or following features, the method further including providing, based on the characterized well and completed reservoir, dynamic parameters for well and the associated reservoir.

A fifth feature, combinable with any of the previous or following features, the method further including using the dynamic parameters to generate reservoir simulation models for understanding development and management of a reservoir, and to predict future performance with production and injection.

A sixth feature, combinable with any of the previous or following features, where the forecast of future production rates estimates of future sales revenue include monthly and yearly forecasts.

In a second implementation, a non-transitory, computer-readable medium stores one or more instructions executable by a computer system to perform operations including the following. Discrete data for production of a well and an associated reservoir are arranged in chronological order over a time period. First- and second-order derivatives of pressure versus a time series in the well and the associated reservoir are determined at a first focal point in the time period. The first- and second-order derivatives are determined using a five-point function. The five-point function considers beginning and ending points in the time period. The first- and second-order derivatives are determined at a next focal point following the determination of the first- and second-order derivatives for the first focal point. The first- and second-order derivatives are determined at all the successive focal points, applying the terminal corrections wherever deemed necessary. Numerical values and plots of first- and second-order derivative profiles that are based on the first- and second-order derivatives are presented in a user interface. Diagnostic plots and data for determining geological features for the associated reservoir and well parameters for the well are generated using the first- and second-order derivative profiles. Reservoir simulation models are executed using an input reservoir description, including well and reservoir parameters, to generate a forecast of future production rates under different constraints. A production strategy and future development plans for the well are managed, and estimates of future sales revenue for the well are provided using the forecast of future production rates.

The foregoing and other described implementations can each, optionally, include one or more of the following features:

A first feature, combinable with any of the following features, where the discrete data includes: well pressure versus time, production/injection versus time, petrophysical parameters, and rock and fluid properties.

A second feature, combinable with any of the previous or following features, where the well is an oil well, a gas well, or a water well.

A third feature, combinable with any of the previous or following features, the operations further including combining data obtained from drill-stem tests of the well with fluid production and injection rates and rock and fluid properties; and characterizing the well and a completed reservoir of the well using the combined data.

A fourth feature, combinable with any of the previous or following features, the operations further including providing, based on the characterized well and completed reservoir, dynamic parameters for well and the associated reservoir.

A fifth feature, combinable with any of the previous or following features, the operations further including using the dynamic parameters to generate reservoir simulation models for understanding development and management of a reservoir, and to predict future performance with production and injection.

A sixth feature, combinable with any of the previous or following features, where the forecast of future production rates estimates of future sales revenue include monthly and yearly forecasts.

In a third implementation, a computer-implemented system includes one or more processors and a non-transitory computer-readable storage medium coupled to the one or more processors and storing programming instructions for execution by the one or more processors. The programming instructions instruct the one or more processors to perform operations including the following.

Discrete data for production of a well and an associated reservoir are arranged in chronological order over a time period. First- and second-order derivatives of pressure versus a time series in the well and the associated reservoir are determined at a first focal point in the time period. The first- and second-order derivatives are determined using a five-point function. The five-point function considers beginning and ending points in the time period. The first- and second-order derivatives are determined at a next focal point following the determination of the first- and second-order derivatives for the first focal point. The first- and second-order derivatives are determined at all the successive focal points, applying the terminal corrections wherever deemed necessary. Numerical values and plots of first- and second-order derivative profiles that are based on the first- and second-order derivatives are presented in a user interface. Diagnostic plots and data for determining geological features for the associated reservoir and well parameters for the well are generated using the first- and second-order derivative profiles. Reservoir simulation models are executed using an input reservoir description, including well and reservoir parameters, to generate a forecast of future production rates under different constraints. A production strategy and future development plans for the well are managed, and estimates of future sales revenue for the well are provided using the forecast of future production rates.

The foregoing and other described implementations can each, optionally, include one or more of the following features:

A first feature, combinable with any of the following features, where the discrete data includes: well pressure versus time, production/injection versus time, petrophysical parameters, and rock and fluid properties.

A second feature, combinable with any of the previous or following features, where the well is an oil well, a gas well, or a water well.

A third feature, combinable with any of the previous or following features, the operations further including combining data obtained from drill-stem tests of the well with fluid production and injection rates and rock and fluid properties; and characterizing the well and a completed reservoir of the well using the combined data.

A fourth feature, combinable with any of the previous or following features, the operations further including providing, based on the characterized well and completed reservoir, dynamic parameters for well and the associated reservoir.

A fifth feature, combinable with any of the previous or following features, the operations further including using the dynamic parameters to generate reservoir simulation models for understanding development and management of a reservoir, and to predict future performance with production and injection.

Implementations of the subject matter and the functional operations described in this specification can be implemented in digital electronic circuitry, in tangibly embodied computer software or firmware, in computer hardware, including the structures disclosed in this specification and their structural equivalents, or in combinations of one or more of them. Software implementations of the described subject matter can be implemented as one or more computer programs. Each computer program can include one or more modules of computer program instructions encoded on a tangible, non-transitory, computer-readable computer-storage medium for execution by, or to control the operation of, data processing apparatus. Alternatively, or additionally, the program instructions can be encoded in/on an artificially generated propagated signal. For example, the signal can be a machine-generated electrical, optical, or electromagnetic signal that is generated to encode information for transmission to a suitable receiver apparatus for execution by a data processing apparatus. The computer-storage medium can be a machine-readable storage device, a machine-readable storage substrate, a random or serial access memory device, or a combination of computer-storage mediums.

The terms “data processing apparatus,” “computer,” and “electronic computer device” (or equivalent as understood by one of ordinary skill in the art) refer to data processing hardware. For example, a data processing apparatus can encompass all kinds of apparatuses, devices, and machines for processing data, including by way of example, a programmable processor, a computer, or multiple processors or computers. The apparatus can also include special purpose logic circuitry including, for example, a central processing unit (CPU), a field-programmable gate array (FPGA), or an application-specific integrated circuit (ASIC). In some implementations, the data processing apparatus or special purpose logic circuitry (or a combination of the data processing apparatus or special purpose logic circuitry) can be hardware- or software-based (or a combination of both hardware- and software-based). The apparatus can optionally include code that creates an execution environment for computer programs, for example, code that constitutes processor firmware, a protocol stack, a database management system, an operating system, or a combination of execution environments. The present disclosure contemplates the use of data processing apparatuses with or without conventional operating systems, such as LINUX, UNIX, WINDOWS, MAC OS, ANDROID, or IOS.

A computer program, which can also be referred to or described as a program, software, a software application, a module, a software module, a script, or code, can be written in any form of programming language. Programming languages can include, for example, compiled languages, interpreted languages, declarative languages, or procedural languages. Programs can be deployed in any form, including as stand-alone programs, modules, components, subroutines, or units for use in a computing environment. A computer program can, but need not, correspond to a file in a file system. A program can be stored in a portion of a file that holds other programs or data, for example, one or more scripts stored in a markup language document, in a single file dedicated to the program in question, or in multiple coordinated files storing one or more modules, sub-programs, or portions of code. A computer program can be deployed for execution on one computer or on multiple computers that are located, for example, at one site or distributed across multiple sites that are interconnected by a communication network. While portions of the programs illustrated in the various figures may be shown as individual modules that implement the various features and functionality through various objects, methods, or processes, the programs can instead include a number of sub-modules, third-party services, components, and libraries. Conversely, the features and functionality of various components can be combined into single components as appropriate. Thresholds used to make computational determinations can be statically, dynamically, or both statically and dynamically determined.

The methods, processes, or logic flows described in this specification can be performed by one or more programmable computers executing one or more computer programs to perform functions by operating on input data and generating output. The methods, processes, or logic flows can also be performed by, and apparatus can also be implemented as, special purpose logic circuitry, for example, a CPU, an FPGA, or an ASIC.

Computers suitable for the execution of a computer program can be based on one or more of general and special purpose microprocessors and other kinds of CPUs. The elements of a computer are a CPU for performing or executing instructions and one or more memory devices for storing instructions and data. Generally, a CPU can receive instructions and data from (and write data to) a memory.

Graphics processing units (GPUs) can also be used in combination with CPUs. The GPUs can provide specialized processing that occurs in parallel to processing performed by CPUs. The specialized processing can include artificial intelligence (AI) applications and processing, for example. GPUs can be used in GPU clusters or in multi-GPU computing.

A computer can include, or be operatively coupled to, one or more mass storage devices for storing data. In some implementations, a computer can receive data from, and transfer data to, the mass storage devices including, for example, magnetic, magneto-optical disks, or optical disks. Moreover, a computer can be embedded in another device, for example, a mobile telephone, a personal digital assistant (PDA), a mobile audio or video player, a game console, a global positioning system (GPS) receiver, or a portable storage device such as a universal serial bus (USB) flash drive.

Computer-readable media (transitory or non-transitory, as appropriate) suitable for storing computer program instructions and data can include all forms of permanent/non-permanent and volatile/non-volatile memory, media, and memory devices. Computer-readable media can include, for example, semiconductor memory devices such as random access memory (RAM), read-only memory (ROM), phase change memory (PRAM), static random access memory (SRAM), dynamic random access memory (DRAM), erasable programmable read-only memory (EPROM), electrically erasable programmable read-only memory (EEPROM), and flash memory devices. Computer-readable media can also include, for example, magnetic devices such as tape, cartridges, cassettes, and internal/removable disks. Computer-readable media can also include magneto-optical disks and optical memory devices and technologies including, for example, digital video disc (DVD), CD-ROM, DVD+/−R, DVD-RAM, DVD-ROM, HD-DVD, and BLU-RAY. The memory can store various objects or data, including caches, classes, frameworks, applications, modules, backup data, jobs, web pages, web page templates, data structures, database tables, repositories, and dynamic information. Types of objects and data stored in memory can include parameters, variables, algorithms, instructions, rules, constraints, and references. Additionally, the memory can include logs, policies, security or access data, and reporting files. The processor and the memory can be supplemented by, or incorporated into, special purpose logic circuitry.

Implementations of the subject matter described in the present disclosure can be implemented on a computer having a display device for providing interaction with a user, including displaying information to (and receiving input from) the user. Types of display devices can include, for example, a cathode ray tube (CRT), a liquid crystal display (LCD), a light-emitting diode (LED), and a plasma monitor. Display devices can include a keyboard and pointing devices including, for example, a mouse, a trackball, or a trackpad. User input can also be provided to the computer through the use of a touchscreen, such as a tablet computer surface with pressure sensitivity or a multi-touch screen using capacitive or electric sensing. Other kinds of devices can be used to provide for interaction with a user, including to receive user feedback including, for example, sensory feedback including visual feedback, auditory feedback, or tactile feedback. Input from the user can be received in the form of acoustic, speech, or tactile input. In addition, a computer can interact with a user by sending documents to, and receiving documents from, a device that the user uses. For example, the computer can send web pages to a web browser on a user's client device in response to requests received from the web browser.

The term “graphical user interface,” or “GUI,” can be used in the singular or the plural to describe one or more graphical user interfaces and each of the displays of a particular graphical user interface. Therefore, a GUI can represent any graphical user interface, including, but not limited to, a web browser, a touch-screen, or a command line interface (CLI) that processes information and efficiently presents the information results to the user. In general, a GUI can include a plurality of user interface (UI) elements, some or all associated with a web browser, such as interactive fields, pull-down lists, and buttons. These and other UI elements can be related to or represent the functions of the web browser.

Implementations of the subject matter described in this specification can be implemented in a computing system that includes a back-end component, for example, as a data server, or that includes a middleware component, for example, an application server. Moreover, the computing system can include a front-end component, for example, a client computer having one or both of a graphical user interface or a Web browser through which a user can interact with the computer. The components of the system can be interconnected by any form or medium of wireline or wireless digital data communication (or a combination of data communication) in a communication network. Examples of communication networks include a local area network (LAN), a radio access network (RAN), a metropolitan area network (MAN), a wide area network (WAN), Worldwide Interoperability for Microwave Access (WIMAX), a wireless local area network (WLAN) (for example, using 802.11 a/b/g/n or 802.20 or a combination of protocols), all or a portion of the Internet, or any other communication system or systems at one or more locations (or a combination of communication networks). The network can communicate with, for example, Internet Protocol (IP) packets, frame relay frames, asynchronous transfer mode (ATM) cells, voice, video, data, or a combination of communication types between network addresses.

The computing system can include clients and servers. A client and server can generally be remote from each other and can typically interact through a communication network. The relationship of client and server can arise by virtue of computer programs running on the respective computers and having a client-server relationship.

Cluster file systems can be any file system type accessible from multiple servers for read and update. Locking or consistency tracking may not be necessary since the locking of exchange file system can be done at application layer. Furthermore, Unicode data files can be different from non-Unicode data files.

While this specification contains many specific implementation details, these should not be construed as limitations on the scope of what may be claimed, but rather as descriptions of features that may be specific to particular implementations. Certain features that are described in this specification in the context of separate implementations can also be implemented, in combination, in a single implementation. Conversely, various features that are described in the context of a single implementation can also be implemented in multiple implementations, separately, or in any suitable sub-combination. Moreover, although previously described features may be described as acting in certain combinations and even initially claimed as such, one or more features from a claimed combination can, in some cases, be excised from the combination, and the claimed combination may be directed to a sub-combination or variation of a sub-combination.

Particular implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional), to achieve desirable results. In certain circumstances, multitasking or parallel processing (or a combination of multitasking and parallel processing) may be advantageous and performed as deemed appropriate.

Moreover, the separation or integration of various system modules and components in the previously described implementations should not be understood as requiring such separation or integration in all implementations. It should be understood that the described program components and systems can generally be integrated together in a single software product or packaged into multiple software products.

Accordingly, the previously described example implementations do not define or constrain the present disclosure. Other changes, substitutions, and alterations are also possible without departing from the spirit and scope of the present disclosure.

Furthermore, any claimed implementation is considered to be applicable to at least a computer-implemented method; a non-transitory, computer-readable medium storing computer-readable instructions to perform the computer-implemented method; and a computer system including a computer memory interoperably coupled with a hardware processor configured to perform the computer-implemented method or the instructions stored on the non-transitory, computer-readable medium.

What is claimed is:

1. A computer-implemented method, comprising:
arranging, in chronological order, discrete data for production of a well and an associated reservoir over a time period;
determining, at a first focal point in the time period, first- and second-order derivatives of pressure versus a time series in the well and the associated reservoir, wherein the first- and second-order derivatives are determined using a five-point function, and wherein the five-point function considers beginning and ending points in the time period;
determining, following the first- and second-order derivatives determined for the first focal point, the first- and second-order derivatives at a next (second) focal point;
determining, applying the terminal corrections wherever deemed necessary, the first- and second-order derivatives at all the successive focal points;
presenting, in a user interface, numerical values and plots of first- and second-order derivative profiles based on the first- and second-order derivatives;
generating, using the first- and second-order derivative profiles, diagnostic plots and data for determining geological features for the associated reservoir and well parameters for the well;
executing reservoir simulation models using an input reservoir description, including well and reservoir parameters, to generate a forecast of future production rates under different constraints; and
managing a production strategy and future development plans for the well and providing estimates of future sales revenue for the well using the forecast of future production rates.

2. The computer-implemented method of claim 1, wherein the discrete data includes: well pressure versus time, production/injection versus time, petrophysical parameters, and rock and fluid properties.

3. The computer-implemented method of claim 1, wherein the well is an oil well, a gas well, or a water well.

4. The computer-implemented method of claim 1, further comprising:
combining data obtained from drill-stem tests of the well with fluid production and injection rates and rock and fluid properties; and
characterizing the well and a completed reservoir of the well using the combined data.

5. The computer-implemented method of claim 4, further comprising:
providing, based on the characterized well and completed reservoir, dynamic parameters for well and the associated reservoir.

6. The computer-implemented method of claim 5, further comprising:
using the dynamic parameters to generate reservoir simulation models for understanding development and management of a reservoir, and to predict future performance with production and injection.

7. The computer-implemented method of claim 1, wherein the forecast of future production rates estimates of future sales revenue include monthly and yearly forecasts.

8. A non-transitory, computer-readable medium storing one or more instructions executable by a computer system to perform operations comprising:
arranging, in chronological order, discrete data for production of a well and an associated reservoir over a time period;
determining, at a first focal point in the time period, first- and second-order derivatives of pressure versus a time series in the well and the associated reservoir, wherein the first- and second-order derivatives are determined using a five-point function, and wherein the five-point function considers beginning and ending points in the time period;
determining, following the first- and second-order derivatives determined for the first focal point, the first- and second-order derivatives at a next (second) focal point;
determining, applying the terminal corrections wherever deemed necessary, the first- and second-order derivatives at all the successive focal points;
presenting, in a user interface, numerical values and plots of first- and second-order derivative profiles based on the first- and second-order derivatives;
generating, using the first- and second-order derivative profiles, diagnostic plots and data for determining geological features for the associated reservoir and well parameters for the well;
executing reservoir simulation models using an input reservoir description, including well and reservoir parameters, to generate a forecast of future production rates under different constraints; and
managing a production strategy and future development plans for the well and providing estimates of future sales revenue for the well using the forecast of future production rates.

9. The non-transitory, computer-readable medium of claim 8, wherein the discrete data includes:
well pressure versus time, production/injection versus time, petrophysical parameters, and rock and fluid properties.

10. The non-transitory, computer-readable medium of claim 8, wherein the well is an oil well, a gas well, or a water well.

11. The non-transitory, computer-readable medium of claim 8, the operations further comprising:
combining data obtained from drill-stem tests of the well with fluid production and injection rates and rock and fluid properties; and
characterizing the well and a completed reservoir of the well using the combined data.

12. The non-transitory, computer-readable medium of claim 11, the operations further comprising:
providing, based on the characterized well and completed reservoir, dynamic parameters for well and the associated reservoir.

13. The non-transitory, computer-readable medium of claim 12, the operations further comprising:
using the dynamic parameters to generate reservoir simulation models for understanding development and management of a reservoir, and to predict future performance with production and injection.

14. The non-transitory, computer-readable medium of claim 13, wherein the forecast of future production rates estimates of future sales revenue include monthly and yearly forecasts.

15. A computer-implemented system, comprising:
one or more processors; and
a non-transitory computer-readable storage medium coupled to the one or more processors and storing programming instructions for execution by the one or more processors, the programming instructions instructing the one or more processors to perform operations comprising:
arranging, in chronological order, discrete data for production of a well and an associated reservoir over a time period;
determining, at a first focal point in the time period, first- and second-order derivatives of pressure versus a time series in the well and the associated reservoir, wherein the first- and second-order derivatives are determined using a five-point function, and wherein the five-point function considers beginning and ending points in the time period;
determining, following the first- and second-order derivatives determined for the first focal point, the first- and second-order derivatives at a next (second) focal point;
determining, applying the terminal corrections wherever deemed necessary, the first- and second-order derivatives at all the successive focal points;
presenting, in a user interface, numerical values and plots of first- and second-order derivative profiles based on the first- and second-order derivatives;
generating, using the first- and second-order derivative profiles, diagnostic plots and data for determining geological features for the associated reservoir and well parameters for the well;
executing reservoir simulation models using an input reservoir description, including well and reservoir parameters, to generate a forecast of future production rates under different constraints; and
managing a production strategy and future development plans for the well and providing estimates of future sales revenue for the well using the forecast of future production rates.

16. The computer-implemented system of claim 15, wherein the discrete data includes: well pressure versus time, production/injection versus time, petrophysical parameters, and rock and fluid properties.

17. The computer-implemented system of claim 15, wherein the well is an oil well, a gas well, or a water well.

18. The computer-implemented system of claim 15, the operations further comprising:
combining data obtained from drill-stem tests of the well with fluid production and injection rates and rock and fluid properties; and
characterizing the well and a completed reservoir of the well using the combined data.

19. The computer-implemented system of claim 18, the operations further comprising:
providing, based on the characterized well and completed reservoir, dynamic parameters for well and the associated reservoir.

20. The computer-implemented system of claim 19, the operations further comprising:
using the dynamic parameters to generate reservoir simulation models for understanding development and management of a reservoir, and to predict future performance with production and injection.
